(19) United States
(12) Patent Application Publication
(10) Pub. No.: US 2025/0102933 A1
(43) Pub. Date: Mar. 27, 2025

(54) ELECTROPHOTOGRAPHIC PHOTORECEPTOR, PROCESS CARTRIDGE, AND IMAGE FORMING APPARATUS

(71) Applicant: FUJIFILM Business Innovation Corp., Tokyo (JP)

(72) Inventors: Yuki OYAMADA, Kanagawa (JP); Masahiro IWASAKI, Kanagawa (JP)

(73) Assignee: FUJIFILM Business Innovation Corp., Tokyo (JP)

(21) Appl. No.: 18/586,550

(22) Filed: Feb. 26, 2024

(30) Foreign Application Priority Data
Sep. 25, 2023 (JP) 2023-161677

(51) Int. Cl. G03G 5/14

(52) U.S. Cl. CPC G03G 5/142; G03G 2215/00957; G03G 2215/00962; G03G 2221/183

(57) ABSTRACT

An electrophotographic photoreceptor includes a conductive substrate, an undercoat layer that is provided on the conductive substrate, and a photosensitive layer provided on the undercoat layer, in which the undercoat layer contains a binder resin and an electron transport material having a crystal density of 1.62 g/cm³ or greater, and a full width at half maximum (FWHM) of a maximum intensity peak in an X-ray diffraction spectrum measured in a thickness direction is 5.0 or less.

### CROSS-REFERENCE TO RELATED APPLICATIONS

This application is based on and claims priority under 35 USC 119 from Japanese Patent Application No. 2023-161677 filed Sep. 25, 2023.

### BACKGROUND

### (i) Technical Field

The present invention relates to an electrophotographic photoreceptor, a process cartridge, and an image forming apparatus.

### (ii) Related Art

In an electrophotographic image forming apparatus, typically, a surface of an electrophotographic photoreceptor is charged to a predetermined polarity and a predetermined potential using a charging unit, the charges of the charged surface of the electrophotographic photoreceptor are selectively erased by performing image exposure to light to form an electrostatic latent image, a toner is made to adhere to the electrostatic latent image using a developing unit, and the latent image is developed as a toner image. Further, the toner image is transferred to a medium to be transferred by a transfer unit to discharge an image formed product. In recent years, electrophotographic photoreceptors have advantages that a high speed and a high print quality can be obtained, and thus have been widely used in the fields such as copying machines and laser beam printers.

Recently, an electrophotographic photoreceptor is formed such that an undercoat layer is formed on a conductive support layer such as an aluminum base material and a photosensitive layer is sequentially formed on the undercoat layer in many cases.

The undercoat layer is required to cover defects of the base material, suppress charge injection to the photosensitive layer in a case of application of a voltage to the electrophotographic photoreceptor, and control the resistance. Meanwhile, the undercoat layer is also required to suppress the charge generated by the photosensitive layer from staying inside the photoreceptor, that is, to have charge transporting properties.

JP1999-202520A discloses an electrophotographic photoreceptor formed by sequentially providing an undercoat layer and a photosensitive layer on a conductive support, in which the undercoat layer contains dichlorotin phthalocyanine and a binder resin.

JP1991-216662A discloses an electrophotographic photoreceptor formed by sequentially laminating an undercoat layer, a charge generation layer, and a charge transport layer on a conductive layer, in which the undercoat layer contains a binder, an organic charge generation material, and a specific diphenoquinone derivative.

JP1993-249719A discloses an electrophotographic photoreceptor formed by providing a photosensitive layer containing a charge generation agent on a conductive support, in which the charge generation agent is obtained by sublimation purifying and dry pulverizing a specific benzimidazole perylene pigment, a crystal shape is provided at Bragg angles (2θ+0.2°) of 2θ=6.2°, 12.3°, and 26.8° in X-ray diffraction measurement of powder in a non-alignment state using CuKα-rays as a light source, and a half-width S (26.8°) of 26.8° satisfies Expression of S (26.8°)≥0.5.

JP1999-184129A discloses an electrophotographic photoreceptor formed by sequentially laminating an undercoat layer and a photosensitive layer on a conductive support, in which the undercoat layer contains an organic pigment and a rosin compound in a polyamide resin.

### SUMMARY

In the related art, an electrophotographic photoreceptor including a conductive substrate, an undercoat layer, and a photosensitive layer, the charge maintainability tends to decrease in a case where the electron transport properties are improved.

Aspects of non-limiting embodiments of the present disclosure relate to an electrophotographic photoreceptor with excellent electron transport properties as compared with a case where a full width at half maximum (FWHM) of a maximum intensity peak in an X-ray diffraction spectrum measured in a thickness direction of the undercoat layer containing a binder resin and an electron transport material is greater than 5.0° or a case where a crystal density of the electron transport material is less than 1.62 g/cm³.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

Specific means for achieving the above-described object includes the following aspects.

According to an aspect of the present disclosure, there is provided an electrophotographic photoreceptor including: a conductive substrate; an undercoat layer that is provided on the conductive substrate; and a photosensitive layer provided on the undercoat layer, in which the undercoat layer contains a binder resin and an electron transport material having a crystal density of 1.62 g/cm³ or greater, and a full width at half maximum (FWHM) of a maximum intensity peak in an X-ray diffraction spectrum measured in a thickness direction is 5.0° or less.

### BRIEF DESCRIPTION OF THE DRAWINGS

Exemplary embodiment(s) of the present invention will be described in detail based on the following figures, wherein:

FIG. 1 is a schematic partial cross-sectional view showing an example of a layer configuration of an electrophotographic photoreceptor according to the present exemplary embodiment;

FIG. 2 is a schematic configuration view showing an example of an image forming apparatus according to the present exemplary embodiment; and

FIG. 3 is a schematic configuration view showing another example of the image forming apparatus according to the present exemplary embodiment.

### DETAILED DESCRIPTION

Hereinafter, exemplary embodiments of the present disclosure will be described. The following descriptions and examples merely illustrate the exemplary embodiments, and do not limit the scope of the exemplary embodiments.

In a numerical range described in a stepwise manner in the present disclosure, an upper limit value or a lower limit value described in a certain numerical range may be replaced with an upper limit value or a lower limit value in another numerical range described in a stepwise manner. Further, in a numerical range described in the present disclosure, an upper limit value or a lower limit value described in the numerical range may be replaced with a value shown in examples.

In the present disclosure, each component may include a plurality of kinds of substances corresponding to each component. In the present disclosure, in a case where a plurality of kinds of substances corresponding to each component in a composition are present, the amount of each component in the composition indicates the total amount of the plurality of kinds of substances present in the composition unless otherwise specified.

In the present disclosure, LUMO is an abbreviation for “Lowest Unoccupied Molecular Orbital”.

In the present disclosure, an electrophotographic photoreceptor is also simply referred to as a photoreceptor.

### Electrophotographic Photoreceptor

An electrophotographic photoreceptor according to the present exemplary embodiment includes a conductive substrate, an undercoat layer that is provided on the conductive substrate, and a photosensitive layer provided on the undercoat layer, in which the undercoat layer contains a binder resin and an electron transport material having a crystal density of 1.62 g/cm³ or greater, and a full width at half maximum (FWHM) of a maximum intensity peak in an X-ray diffraction spectrum measured in a thickness direction is 5.0° or less.

The photoreceptor according to the present exemplary embodiment includes a conductive substrate, an undercoat layer disposed on the conductive substrate, and a photosensitive layer disposed on the undercoat layer.

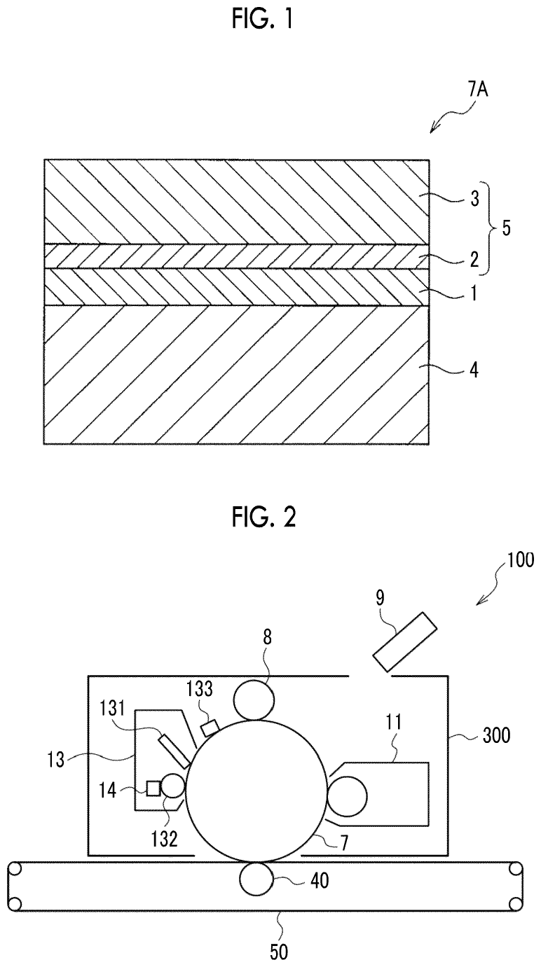

FIG. 1 schematically shows an example of the layer configuration of the photoreceptor according to the present exemplary embodiment. A photoreceptor 7A shown in FIG. 1 has a structure in which an undercoat layer 1, a charge generation layer 2, and a charge transport layer 3 are laminated in this order on a conductive substrate 4. The charge generation layer 2 and the charge transport layer 3 constitute a photosensitive layer 5. The photoreceptor 7A may have a layer configuration in which a protective layer is further provided on the charge transport layer 3.

In the photoreceptor according to the present exemplary embodiment, the photosensitive layer may be a function separation type photosensitive layer in which the charge generation layer 2 and the charge transport layer 3 are separated as in the photoreceptor 7A shown in FIG. 1 or may be a single layer type photosensitive layer having a charge generation ability and a charge transport ability in place of the charge generation layer 2 and the charge transport layer 3.

In order to improve the electron transport properties of the electrophotographic photoreceptor, an electrophotographic photoreceptor including an undercoat layer has been employed. However, in the electrophotographic photoreceptor of the related art which includes an undercoat layer, there is room for improvement in electron transport performance.

Meanwhile, the electrophotographic photoreceptor according to the present exemplary embodiment has the above-described configuration, the electron transport properties are excellent. The mechanism is not necessarily clear, but is assumed as follows.

The undercoat layer in the electrophotographic photoreceptor according to the present exemplary embodiment contains an electron transport material having a crystal density of 1.62 g/cm³ or greater. That is, the crystal density of the electron transport material is relatively higher than in the related art. The crystal density typically denotes the molecular weight in a unit lattice or the volume of a crystal unit lattice. Since the crystal density is relatively high, the electron transport materials tend to be present in close proximity to each other in the undercoat layer. As a result, it is considered that the overlap of the LUMO energy levels between the electron transport materials tends to be large, and thus the electron transport properties are excellent.

Further, the full width at half maximum (FWHM) of the maximum intensity peak in the X-ray diffraction spectrum measured in the thickness direction of the undercoat layer of the electrophotographic photoreceptor according to the present exemplary embodiment is 5.0° or less. The peak in the X-ray diffraction spectrum typically tends to be observed sharply as the purity is higher without mixing of impurities, crystals, and the like and the strain of the crystal lattice is smaller. That is, in a case where the full width at half maximum (FWHM) of the maximum intensity peak is 5.0° or less, the mixing of a plurality of kinds of crystals is small, and the arrangement of the electron transport materials in the undercoat layer is unlikely to be disordered. As a result, the electron transport properties are considered to be more excellent.

Hereinafter, each layer of the photoreceptor according to the present exemplary embodiment will be described in detail.

### Undercoat Layer

The undercoat layer contains a binder resin and an electron transport material having a crystal density of 1.62 g/cm³ or greater, and the full width at half maximum (FWHM) of the maximum intensity peak in the X-ray diffraction spectrum measured in the thickness direction is 5.0° or less.

### Electron Transport Material

The electron transport material has a crystal density of 1.62 g/cm³ or greater, for example, preferably 1.64 g/cm³ or greater and 3.00 g/cm³ or less, more preferably 1.66 g/cm³ or greater and 2.50 g/cm³ or less, and still more preferably 1.68 g/cm³ or greater and 1.90 g/cm³ or less.

In a case where the crystal density of the electron transport material is 1.62 g/cm³ or greater, that is, the crystal density is relatively high, the molecules tend to be present in close proximity to each other in the crystal structure. As a result, it is considered that the overlap of the LUMO energy levels between the electron transport materials tends to be large, and thus the electron transport properties are excellent.

In a case where the crystal density of the electron transport material is 3.00 g/cm³ or less, the molecules are suppressed from being extremely close to each other in the crystal structure. As a result, it is assumed that the repulsion of the energy between the molecules is likely to be suppressed and thus the stability of the crystal structure is more excellent.

The crystal density of the electron transport material is determined in the following manner.

The layer on the outer peripheral side of the undercoat layer in the electrophotographic photoreceptor, that is, the photosensitive layer is removed by using a solvent so that only the conductive substrate and the undercoat layer remain. Further, the undercoat layer is peeled off from the conductive substrate, the volume average particle diameter of the electron transport material contained in the undercoat layer is adjusted to 5 μm or less, and X-ray diffraction measurement (XRD measurement) is performed. The obtained X-ray diffraction profile is collated with a database (for example, Cambridge Structural Database: CSD, Crystallography Open Database: COD or the like) and subjected to identification with compounds in which the X-ray diffraction peak positions match each other. In a case where the electron transport material can be identified by collation with the database, the crystal density is determined from the CIF file of the electron transport material described in the database.

In a case where the corresponding X-ray diffraction profile is not present after the collation of the obtained X-ray diffraction profile with the database, the molecular structure of the electron transport material is clarified by chemical analysis (for example, elemental analysis), single crystals of the electron transport material are prepared, and the crystal structure is determined from the single crystal X-ray structure analysis. The crystal density is calculated from the volume of the unit lattice and the mass of the atoms contained in the unit lattice based on the obtained crystal structure data.

A method of setting the crystal density of the electron transport material to be in the above-described range is not particularly limited, and examples thereof include employing a molecular structure with less steric hindrance, forming the electron transport material to have a molecular structure with high planarity three-dimensionally (for example, forming a structure having a skeleton capable of carrying out an intermolecular interaction such as 7E-71 stacking); and setting the kind of the electron transport material as in the specification having at least one of an electron transport material represented by General Formula (P) or an electron transport material represented by General Formula (Q).

The average primary particle diameter of the electron transport material is, for example, preferably 500 nm or less, more preferably 30 nm or greater and 400 nm or less, and still more preferably 50 nm or greater and 200 nm or less.

In a case where the average primary particle diameter of the electron transport material is 500 nm or less, since the electron transport material is difficult to localize in the undercoat layer and is likely to be present with high dispersibility, the electron transport properties are more excellent. In a case where the average primary particle diameter of the electron transport material is 30 nm or greater, aggregation of the electron transport material is suppressed, the electron transport material is likely to be present with high dispersibility in the undercoat layer, and thus the electron transport properties are more excellent.

The average primary particle diameter of the electron transport material is determined in the following manner.

The electron transport material is specified by observing the laminated cross section of the undercoat layer of the electrophotographic photoreceptor in the thickness direction at a magnification of 5,000 times using a scanning electron microscope (SEM). Here, the electron transport material is present in the form of a solid substance in the binder resin, and the contour of the electron transport material can be recognized by a slight step at the interface between the binder resin and the electron transport material. The electron transport material is specified by the recognition of the contour.

Further, the equivalent circle diameters of any 10 particles present as the primary particles in the electron transport material present in the obtained SEM image are determined. The arithmetic average value of the obtained equivalent circle diameters is defined as the average primary particle diameter of the electron transport material.

The electron transport material has, for example, an aspect ratio of preferably 1.0 or greater and 2.5 or less, more preferably 1.2 or greater and 2.4 or less, and still more preferably 1.5 or greater and 2.3 or less.

In a case where the aspect ratio of the electron transport material is 2.5 or less, since the electron transport material is difficult to localize in the undercoat layer and is likely to be present with high dispersibility, the electron transport properties are more excellent.

The aspect ratio of the electron transport material denotes a ratio (length of major axis/length of minor axis) of the length of the major axis of the electron transport material to the length of the minor axis of the electron transport material.

The length of the electron transport material in the major axis direction denotes the distance of the longest straight line formed by connecting one end portion and the other end portion of the electron transport material in the major axis direction. The length of the electron transport material in the minor axis direction denotes the distance of the longest straight line formed by connecting one end portion and the other end portion of the electron transport material in a direction orthogonal to the major axis.

The aspect ratio of the electron transport material is determined in the following manner. The electron transport material is specified by removing the photosensitive layer (and the protective layer as necessary) from the electrophotographic photoreceptor and observing the undercoat layer with a field emission scanning electron microscope (JSM-6700F, manufactured by JEOL Ltd.) at a magnification of 3,000 to 100,000. Here, the electron transport material is present in the form of a solid substance in the binder resin, and the contour of the electron transport material can be recognized by a slight step at the interface between the binder resin and the electron transport material. The electron transport material is specified by the recognition of the contour.

The length of the major axis and the length of the minor axis are measured at any 100 points of the electron transport material on the obtained micrograph, and each of the aspect ratios (length of major axis/length of minor axis) is determined. Further, the arithmetic average value of the obtained aspect ratios is defined as the aspect ratio of the electron transport material.

A method of adjusting the average primary particle diameter and the aspect ratio of the electron transport material to be in the above-described ranges is not particularly limited, and examples thereof include a method of pulverizing the electron transport material or a coating solution for forming an undercoat layer which contains the electron transport material with a ball mill, a bead mill, a mortar, a sand mill, a kneader, an attritor, or the like and a method of precipitating microcrystals by dissolving the electron transport material in fluoroacetic acid, sulfuric acid, or the like and bringing the mixture into contact with water or a poor solvent.

From the viewpoint of adjusting the crystal density to be in the above-described ranges and setting the full width at half maximum (FWHM) of the maximum intensity peak in the X-ray diffraction spectrum measured in the thickness direction to 5.0° or less, the undercoat layer contains, for example, preferably at least one of an electron transport material represented by General Formula (P) or an electron transport material represented by General Formula (Q) and more preferably an electron transport material represented by General Formula (P) as the electron transport material.

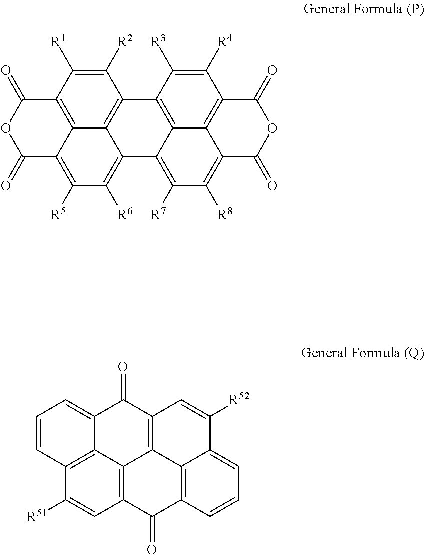

In General Formula (P), R¹, R², R³, R⁴, R⁵, R⁶, R⁷, and R⁸ each independently represent a hydrogen atom, an alkyl group, an alkoxy group, an aralkyl group, an aryl group, an alkoxycarbonyl group, or a halogen atom.

In General Formula (Q), R⁵¹ and R⁵² each independently represent a hydrogen atom, an alkyl group, an alkoxy group, an aralkyl group, an aryl group, an alkoxycarbonyl group, or a halogen atom.

The electron transport material represented by General Formula (P) and the electron transport material represented by General Formula (Q) have excellent electron transport properties and low positive hole transport properties. Therefore, it is considered that in a case where the undercoat layer contains at least one of the electron transport material represented by General Formula (P) or the electron transport material represented by General Formula (Q), the undercoat layer has excellent electron transport properties and further reduces dark decay, and thus the charge maintainability is excellent.

### Electron Transport Material Represented by General Formula (P)

Hereinafter, the electron transport material represented by General Formula (P) will be described.

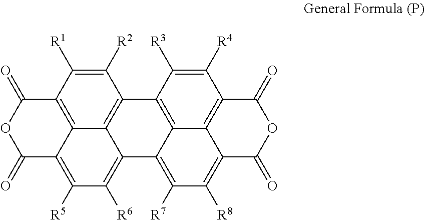

In General Formula (P), R¹, R², R³, R⁴, R⁵, R⁶, R⁷, and R⁸ each independently represent a hydrogen atom, an alkyl group, an alkoxy group, an aralkyl group, an aryl group, an alkoxycarbonyl group, or a halogen atom.

In General Formula (P), R¹, R², R³, R⁴, R⁵, R⁶, R⁷, and R⁸ each independently represent, for example, preferably a hydrogen atom or a halogen atom and more preferably a hydrogen atom.

It is considered that in a case where R¹ to R⁸ in General Formula (P) represent a hydrogen atom or a halogen atom (for example, more preferably a hydrogen atom), the undercoat layer has more excellent electron transport properties and further reduces dark decay, and thus the charge maintainability is more excellent.

Examples of the alkyl group represented by R¹ to R⁸ in General Formula (P) include a substituted or unsubstituted alkyl group.

Examples of the unsubstituted alkyl group represented by R¹ to R⁸ in General Formula (P) include a linear alkyl group having 1 or more and 20 or less carbon atoms (for example, preferably 1 or more and 10 or less carbon atoms and more preferably 1 or more and 6 or less carbon atoms), a branched alkyl group having 3 or more and 20 or less carbon atoms (for example, preferably 3 or more and 10 or less carbon atoms), and a cyclic alkyl group having 3 or more and 20 or less carbon atoms (for example, preferably 3 or more and 10 or less carbon atoms).

Examples of the linear alkyl group having 1 or more and 20 or less carbon atoms include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, a tridecyl group, an n-tetradecyl group, an n-pentadecyl group, an n-heptadecyl group, an n-octadecyl group, an n-nonadecyl group, and an n-icosyl group.

Examples of the branched alkyl group having 3 or more and 20 or less carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, an isododecyl group, a sec-dodecyl group, a tert-dodecyl group, a tert-tetradecyl group, and a tert-pentadecyl group.

Examples of the cyclic alkyl group having 3 or more and 20 or less carbon atoms include a cyclopropyl group, a cyclobutyl group, a cyclopentyl group, a cyclohexyl group, a cycloheptyl group, a cyclooctyl group, a cyclononyl group, a cyclodecyl group, and polycyclic (for example, bicyclic, tricyclic, or spirocyclic) alkyl groups formed by these monocyclic alkyl groups being linked to each other.

Among these, for example, a linear alkyl group such as a methyl group or an ethyl group is preferable as the unsubstituted alkyl group.

Examples of the substituent in the alkyl group include an alkoxy group, a hydroxy group, a carboxy group, a nitro group, and a halogen atom (such as a fluorine atom, a bromine atom, or an iodine atom).

Examples of the alkoxy group that substitutes the hydrogen atom in the alkyl group include the same groups as the groups for the unsubstituted alkoxy group represented by R¹ to R⁸ in General Formula (P).

Examples of the alkoxy group represented by R¹ to R⁸ in General Formula (P) include a substituted or unsubstituted alkoxy group.

Examples of the unsubstituted alkoxy group represented by R¹ to R⁸ in General Formula (P) include a linear, branched, or cyclic alkoxy group having 1 or more and 10 or less carbon atoms (for example, preferably 1 or more and 6 or less carbon atoms and more preferably 1 or more and 4 or less carbon atoms).

Specific examples of the linear alkoxy group include a methoxy group, an ethoxy group, an n-propoxy group, an n-butoxy group, an n-pentyloxy group, an n-hexyloxy group, an n-heptyloxy group, an n-octyloxy group, an n-nonyloxy group, and an n-decyloxy group.

Specific examples of the branched alkoxy group include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, a tert-hexyloxy group, an isoheptyloxy group, a sec-heptyloxy group, a tert-heptyloxy group, an isooctyloxy group, a sec-octyloxy group, a tert-octyloxy group, an isononyloxy group, a sec-nonyloxy group, a tert-nonyloxy group, an isodecyloxy group, a sec-decyloxy group, and a tert-decyloxy group.

Specific examples of the cyclic alkoxy group include a cyclopropoxy group, a cyclobutoxy group, a cyclopentyloxy group, a cyclohexyloxy group, a cycloheptyloxy group, a cyclooctyloxy group, a cyclononyloxy group, and a cyclodecyloxy group.

Among these, for example, a linear alkoxy group is preferable as the unsubstituted alkoxy group.

Examples of the substituent in the alkoxy group include an aryl group, an alkoxycarbonyl group, an aryloxycarbonyl group, a hydroxyl group, a carboxy group, a nitro group, and a halogen atom (such as a fluorine atom, a bromine atom, or an iodine atom).

Examples of the aryl group that substitutes a hydrogen atom in the alkoxy group include the same groups as the groups for the unsubstituted aryl group represented by R¹ to R⁸ in General Formula (P).

Examples of the alkoxycarbonyl group that substitutes a hydrogen atom in the alkoxy group include the same groups as the groups for the unsubstituted alkoxycarbonyl group represented by R¹ to R⁸ in General Formula (P).

Examples of the aryloxycarbonyl group that substitutes a hydrogen atom in the alkoxy group include the same groups as the groups for the unsubstituted aryloxycarbonyl group represented by R¹ to R⁸ in General Formula (P).

Examples of the aralkyl group represented by R¹ to R⁸ in General Formula (P) include a substituted or unsubstituted aralkyl group.

In General Formula (P), as the unsubstituted aralkyl group represented by R¹ to R⁸, for example, an aralkyl group having 7 or more and 30 or less carbon atoms is preferable, an aralkyl group having 7 or more and 16 or less carbon atoms is more preferable, and an aralkyl group having 7 or more and 12 or less carbon atoms is still more preferable.

Examples of the unsubstituted aralkyl group having 7 or more and 30 or less carbon atoms include a benzyl group, a phenylethyl group, a phenylpropyl group, a 4-phenylbutyl group, a phenylpentyl group, a phenylhexyl group, a phenylheptyl group, a phenyloctyl group, a phenylnonyl group, a naphthylmethyl group, a naphthylethyl group, an anthracenylmethyl group, and a phenyl-cyclopentylmethyl group.

Examples of the substituent in the aralkyl group include an alkoxy group, an alkoxycarbonyl group, and a halogen atom (such as a fluorine atom, a bromine atom, or an iodine atom).

Examples of the alkoxy group that substitutes a hydrogen atom in the aralkyl group include the same groups as the groups for the unsubstituted alkoxy group represented by R¹ to R⁸ in General Formula (P).

Examples of the alkoxycarbonyl group that substitutes a hydrogen atom in the aralkyl group include the same groups as the groups for the unsubstituted alkoxycarbonyl group represented by R¹ to R⁸ in General Formula (P).

Examples of the aryl group represented by R¹ to R⁸ in General Formula (P) include a substituted or unsubstituted aryl group.

As the unsubstituted aryl group represented by R¹ to R⁸ in General Formula (P), for example, an aryl group having 6 or more and 30 or less carbon atoms is preferable, an aryl group having 6 or more and 14 or less carbon atoms is more preferable, and an aryl group having 6 or more and 10 or less carbon atoms is still more preferable.

Examples of the aryl group having 6 or more and 30 or less carbon atoms include a phenyl group, a biphenyl group, a 1-naphthyl group, a 2-naphthyl group, a 9-anthryl group, a 9-phenanthryl group, a 1-pyrenyl group, a 5-naphthacenyl group, a 1-indenyl group, a 2-azulenyl group, a 9-fluorenyl group, a biphenylenyl group, an indacenyl group, a fluoranthenyl group, an acenaphthylenyl group, an aceanthrylenyl group, a phenalenyl group, a fluorenyl group, an anthryl group, a bianthracenyl group, a teranthracenyl group, a quarter anthracenyl group, an anthraquinolyl group, a phenanthryl group, a triphenylenyl group, a pyrenyl group, a chrysenyl group, a naphthacenyl group, a preadenyl group, a picenyl group, a perylenyl group, a pentaphenyl group, a pentacenyl group, a tetraphenylenyl group, a hexaphenyl group, a hexacenyl group, a rubisenyl group, and a coronenyl group. Among these, for example, a phenyl group is preferable.

Examples of the substituent in the aryl group include an alkyl group, an alkoxy group, an alkoxycarbonyl group, an aryloxycarbonyl group, and a halogen atom (such as a fluorine atom, a bromine atom, or an iodine atom).

Examples of the alkyl group that substitutes a hydrogen atom in the aryl group include the same groups as the groups for the unsubstituted alkyl group represented by R¹ to R⁸ in General Formula (P).

Examples of the alkoxy group that substitutes a hydrogen atom in the aryl group include the same groups as the groups for the unsubstituted alkoxy group represented by R¹ to R⁸ in General Formula (P).

Examples of the alkoxycarbonyl group that substitutes a hydrogen atom in the aryl group include the same groups as the groups for the unsubstituted alkoxycarbonyl group represented by R¹ to R⁸ in General Formula (P).

Examples of the alkoxycarbonyl group represented by R¹ to R⁸ in General Formula (P) include a substituted or unsubstituted alkoxycarbonyl group.

The number of carbon atoms of the alkyl chain in the unsubstituted alkoxycarbonyl group represented by R¹ to R⁸ in General Formula (P) is, for example, preferably 1 or more and 20 or less, more preferably 1 or more and 15 or less, and still more preferably 1 or more and 10 or less.

Examples of the alkoxycarbonyl group having 1 or more and 20 or less carbon atoms in the alkyl chain include a methoxycarbonyl group, an ethoxycarbonyl group, a propoxycarbonyl group, an isopropoxycarbonyl group, an n-butoxycarbonyl group, a sec-butoxybutylcarbonyl group, a tert-butoxycarbonyl group, a pentaoxycarbonyl group, a hexaoxycarbonyl group, a heptaoxycarbonyl group, an octaoxycarbonyl group, a nonaoxycarbonyl group, a decaoxycarbonyl group, a dodecaoxycarbonyl group, a tridecaoxycarbonyl group, a tetradecaoxycarbonyl group, a pentadecaoxycarbonyl group, a hexadecaoxycarbonyl group, a heptadecaoxycarbonyl group, an octadecaoxycarbonyl group, a nonadecaoxycarbonyl group, and an icosaoxycarbonyl group.

Examples of the substituent in the alkoxycarbonyl group include an aryl group, a hydroxy group, and a halogen atom (such as a fluorine atom, a bromine atom, or an iodine atom). Examples of the aryl group that substitutes a hydrogen atom in the alkoxycarbonyl group include the same groups as the groups for the unsubstituted aryl group represented by R¹ to R⁸ in General Formula (P).

Examples of the halogen atom represented by R¹ to R⁸ in General Formula (P) include a fluorine atom, a chlorine atom, a bromine atom, and an iodine atom.

Hereinafter, exemplary compounds of the electron transport material represented by General Formula (P) will be shown, but the present exemplary embodiment is not limited thereto. Further, the following exemplary compound numbers will be referred to as exemplary compounds (P-numbers) below.

| Example | Exemplary compound of electrons transport |
|---|---|
| No. | material represented by General Formula (P) |
| P-1 | 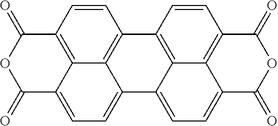 [SMILES: O=C1OC(=O)c2ccc3c4ccc5c6c(ccc(c7ccc1c2c73)c64)C(=O)OC5=O] |
| P-2 | 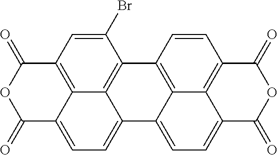 [SMILES: O=C1OC(=O)c2ccc3c4c(Br)cc5c6c(ccc(c7ccc1c2c73)c64)C(=O)OC5=O] |
| P-3 | 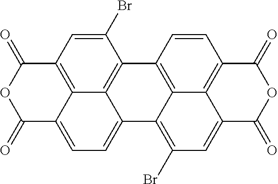 [SMILES: O=C1OC(=O)c2cc(Br)c3c4ccc5c6c(cc(Br)c(c7ccc1c2c73)c64)C(=O)OC5=O] |
| P-4 | 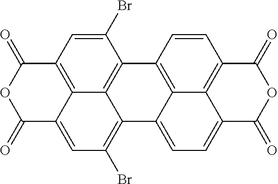 [SMILES: O=C1OC(=O)c2ccc3c4c(Br)cc5c6c(cc(Br)c(c7ccc1c2c73)c64)C(=O)OC5=O] |
| P-5 | 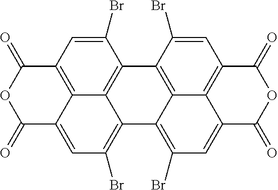 [SMILES: O=C1OC(=O)c2cc(Br)c3c4c(Br)cc5c6c(cc(Br)c(c7c(Br)cc1c2c73)c64)C(=O)OC5=O] |
| P-6 | 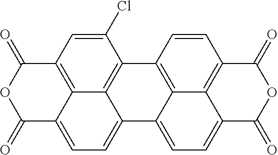 [SMILES: O=C1OC(=O)c2ccc3c4c(Cl)cc5c6c(ccc(c7ccc1c2c73)c64)C(=O)OC5=O] |
| P-7 | 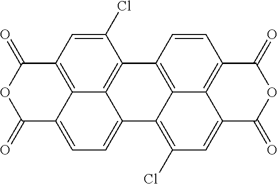 [SMILES: O=C1OC(=O)c2cc(Cl)c3c4ccc5c6c(cc(Cl)c(c7ccc1c2c73)c64)C(=O)OC5=O] |
| P-8 | 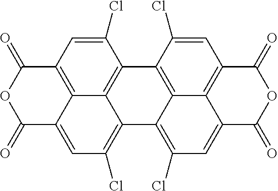 [SMILES: O=C1OC(=O)c2cc(Cl)c3c4c(Cl)cc5c6c(cc(Cl)c(c7c(Cl)cc1c2c73)c64)C(=O)OC5=O] |
| P-9 | 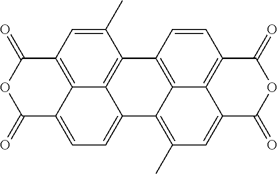 [SMILES: Cc1cc2c3c(ccc4c5c(C)cc6c7c(ccc(c1c34)c75)C(=O)OC6=O)C(=O)OC2=O] |
| P-10 | 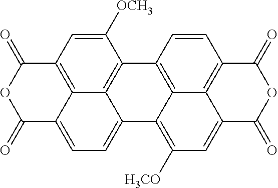 [SMILES: COc1cc2c3c(ccc4c5c(OC)cc6c7c(ccc(c1c34)c75)C(=O)OC6=O)C(=O)OC2=O] |
| P-11 | 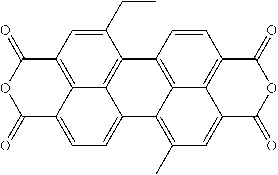 [SMILES: CCc1cc2c3c(ccc4c5c(C)cc6c7c(ccc(c1c34)c75)C(=O)OC6=O)C(=O)OC2=O] |
| P-12 | 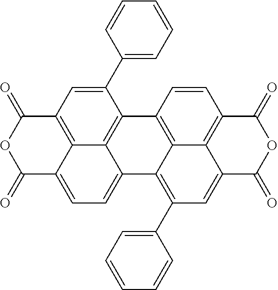 [SMILES: O=C1OC(=O)c2cc(-c3ccccc3)c3c4ccc5c6c(cc(-c7ccccc7)c(c7ccc1c2c73)c64)C(=O)OC5=O] |
| P-13 | 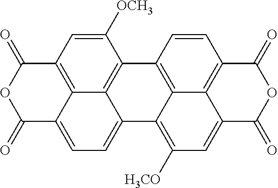 [SMILES: COc1cc2c3c(ccc4c5c(OC)cc6c7c(ccc(c1c34)c75)C(=O)OC6=O)C(=O)OC2=O] |
| P-14 | 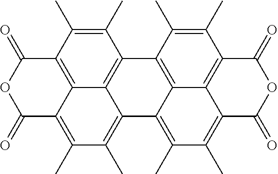 [SMILES: Cc1c2c3c(c(C)c(C)c4c5c(C)c(C)c6c7c(c(C)c(C)c(c(c1C)c34)c75)C(=O)OC6=O)C(=O)OC2=O] |
| P-15 | 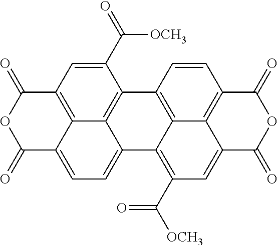 [SMILES: COC(=O)c1cc2c3c(ccc4c5c(C(=O)OC)cc6c7c(ccc(c1c34)c75)C(=O)OC6=O)C(=O)OC2=O] |
| P-16 | 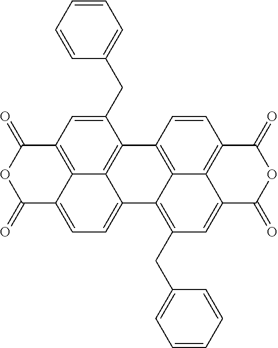 [SMILES: O=C1OC(=O)c2cc(Cc3ccccc3)c3c4ccc5c6c(cc(Cc7ccccc7)c(c7ccc1c2c73)c64)C(=O)OC5=O] |
| P-17 | 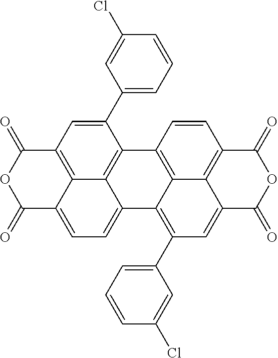 [SMILES: O=C1OC(=O)c2cc(-c3cccc(Cl)c3)c3c4ccc5c6c(cc(-c7cccc(Cl)c7)c(c7ccc1c2c73)c64)C(=O)OC5=O] |
| P-18 | 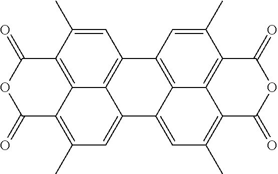 [SMILES: Cc1cc2c3cc(C)c4c5c(c(C)cc(c6cc(C)c7c(c1C(=O)OC7=O)c26)c53)C(=O)OC4=O] |

### Electron Transport Material Represented by General Formula (Q)

Hereinafter, the electron transport material represented by General Formula (Q) will be described.

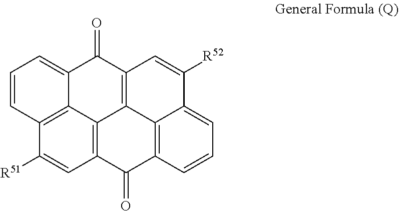

In General Formula (Q), R⁵¹ and R⁵² each independently represent a hydrogen atom, an alkyl group, an alkoxy group, an aralkyl group, an aryl group, an alkoxycarbonyl group, or a halogen atom.

In General Formula (Q), R⁵¹ and R⁵² each independently represent, for example, preferably a hydrogen atom or a halogen atom and more preferably a hydrogen atom.

It is considered that in a case where R⁵¹ to R⁵² in General Formula (Q) represent a hydrogen atom or a halogen atom (for example, more preferably a hydrogen atom), the undercoat layer has more excellent electron transport properties and further reduces dark decay, and thus the charge maintainability is more excellent.

Examples of the alkyl group, the alkoxy group, the aralkyl group, the aryl group, the alkoxycarbonyl group, and the halogen atom represented by R⁵¹ and R⁵² in General Formula (Q) include the same groups and the same atoms as the groups and the atoms for the alkyl group, the alkoxy group, the aralkyl group, the aryl group, the alkoxycarbonyl group, and the halogen atom represented by R¹ to R⁸ in General Formula (P).

The alkyl group, the alkoxy group, the aralkyl group, the aryl group, and the alkoxycarbonyl group represented by R⁵¹ and R⁵² in General Formula (Q) may have the same substituents as the substituents for the alkyl group, the alkoxy group, the aralkyl group, the aryl group, and the alkoxycarbonyl group represented by R¹ to R⁸ in General Formula (P).

R⁵¹ and R⁵² in General Formula (Q) may each independently represent a hydrogen atom, an alkyl group having 1 or more and 12 or less carbon atoms, an alkoxy group having 1 or more and 12 or less carbon atoms, a cycloalkyl group, an aryl group, or an aralkyl group.

Hereinafter, exemplary compounds of the electron transport material represented by General Formula (Q) will be shown, but the present exemplary embodiment is not limited thereto. Further, the following exemplary compound numbers will be referred to as exemplary compounds (Q-numbers) below.

| Example | Exemplary compound of electron transport |
|---|---|
| No. | material represented by General Formula (Q) |
| Q-1 | 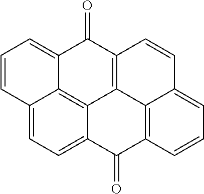 [SMILES: O=c1c2ccc3cccc4c(=O)c5ccc6cccc1c6c5-c2c34] |
| Q-2 | 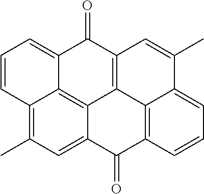 [SMILES: Cc1cc2c3c4c1cccc4c(=O)c1cc(C)c4cccc(c2=O)c4c1-3] |
| Q-3 | 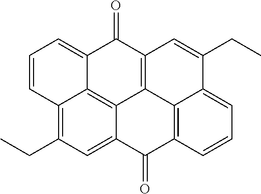 [SMILES: CCc1cc2c3c4c1cccc4c(=O)c1cc(CC)c4cccc(c2=O)c4c1-3] |
| Q-4 | 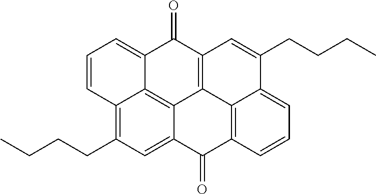 [SMILES: CCCCc1cc2c3c4c1cccc4c(=O)c1cc(CCCC)c4cccc(c2=O)c4c1-3] |
| Q-5 | 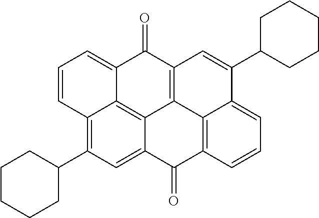 [SMILES: O=c1c2cc(C3CCCCC3)c3cccc4c(=O)c5cc(C6CCCCC6)c6cccc1c6c5-c2c34] |
| Q-6 | 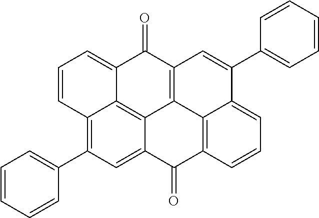 [SMILES: O=c1c2cc(-c3ccccc3)c3cccc4c(=O)c5cc(-c6ccccc6)c6cccc1c6c5-c2c34] |
| Q-7 | 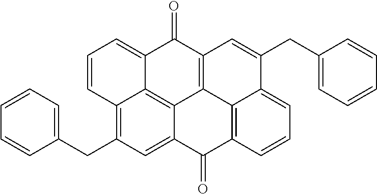 [SMILES: O=c1c2cc(Cc3ccccc3)c3cccc4c(=O)c5cc(Cc6ccccc6)c6cccc1c6c5-c2c34] |
| Q-8 | 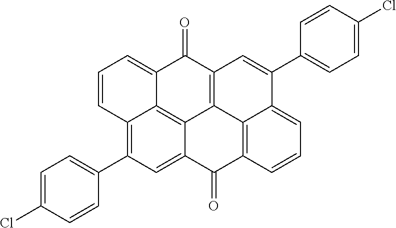 [SMILES: O=c1c2cc(-c3ccc(Cl)cc3)c3cccc4c(=O)c5cc(-c6ccc(Cl)cc6)c6cccc1c6c5-c2c34] |
| Q-9 | 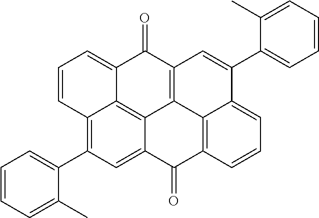 [SMILES: Cc1ccccc1-c1cc2c3c4c1cccc4c(=O)c1cc(-c4ccccc4C)c4cccc(c2=O)c4c1-3] |
| Q-10 | 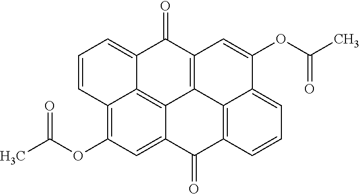 [SMILES: CC(=O)Oc1cc2c3c4c1cccc4c(=O)c1cc(OC(C)=O)c4cccc(c2=O)c4c1-3] |
| Q-11 | 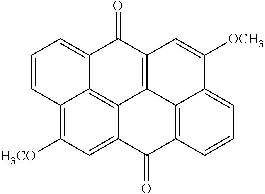 [SMILES: COc1cc2c3c4c1cccc4c(=O)c1cc(OC)c4cccc(c2=O)c4c1-3] |
| Q-12 | 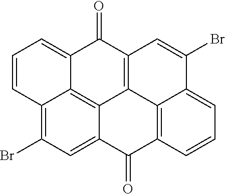 [SMILES: O=c1c2cc(Br)c3cccc4c(=O)c5cc(Br)c6cccc1c6c5-c2c34] |
| Q-13 | 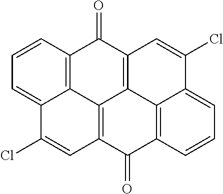 [SMILES: O=c1c2cc(Cl)c3cccc4c(=O)c5cc(Cl)c6cccc1c6c5-c2c34] |

Further, the abbreviations and the like in the above-described exemplary compounds have the following meanings.
Ph: phenyl group
OCH₃: methoxy group
t-C₄H₉O: t-butoxy group
c-C₆H₁₁: cyclohexyl group
C₆H₅: phenyl group
CH₂C₆H₅: benzyl group
3,5-(CH₃)₂-C₆H₃: 3,5-dimethylphenyl group
3,5-Cl₂-C₆H₃:3,5-dichlorophenyl group
Br: bromine atom
Cl: chlorine atom

The undercoat layer may further contain other electron transport materials in addition to the electron transport material represented by General Formula (P) and the electron transport material represented by General Formula (Q) within a range where the effects of the present disclosure are exhibited.

The proportion of the total amount of the electron transport material represented by General Formula (P) and the electron transport material represented by General Formula (Q) in the total amount of the electron transport materials of the undercoat layer is, for example, preferably 80% by mass or greater and 100% by mass or less, more preferably 90% by mass or greater and 100% by mass or less, and still more preferably 95% by mass or greater and 100% by mass or less.

The content of the electron transport material is, for example, preferably 60% by mass or greater, more preferably 60% by mass or greater and 80% by mass or less, and still more preferably 65% by mass or greater and 75% by mass or less with respect to the total content of the binder resin component in the undercoat layer.

In a case where the content of the electron transport material is 80% by mass or less, degradation of the film quality, a decrease in the film forming properties, and occurrence of surface roughness on the undercoat layer are suppressed, and thus both the electron transport properties and the charge maintainability are more excellent. Further, in a case where the content of the electron transport material is 60% by mass or greater, an excess or deficiency of the electron transport ability is suppressed, and thus both the electron transport properties and the charge maintainability are more excellent.

The content of the electron transport material may be less than 60% by mass, 45% by mass or greater and less than 60% by mass, or 50% by mass or greater and less than 60% by mass with respect to the total content of the binder resin component in the undercoat layer.

In the present exemplary embodiment, since the undercoat layer contains an electron transport material having a crystal density of 1.62 g/cm³ or greater and the full width at half maximum (FWHM) of the maximum intensity peak in the X-ray diffraction spectrum measured in the thickness direction is 5.0° or less, the electron transport properties and the charge maintainability are excellent even in a case where the content of the electron transport material is less than 60% by mass.

### Binder Resin

Examples of the binder resin used for the undercoat layer include known polymer compounds such as an acetal resin (such as polyvinyl butyral), a polyvinyl alcohol resin, a polyvinyl acetal resin, a casein resin, a polyamide resin, a cellulose resin, gelatin, a polyurethane resin, a polyester resin, an unsaturated polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a urea resin, a phenol resin, a phenol-formaldehyde resin, a melamine resin, a urethane resin, an alkyd resin, and an epoxy resin; a zirconium chelate compound; a titanium chelate compound; an aluminum chelate compound; a titanium alkoxide compound; an organic titanium compound; and known materials such as a silane coupling agent.

Examples of the binder resin used for the undercoat layer include a charge-transporting resin containing a charge-transporting group, and a conductive resin (such as polyaniline).

Among these, as the binder resin used for the undercoat layer, for example, a resin insoluble in a coating solvent of the upper layer is preferable, and a resin obtained by reaction between a curing agent and at least one resin selected from the group consisting of a thermosetting resin such as a urea resin, a phenol resin, a phenol-formaldehyde resin, a melamine resin, a urethane resin, an unsaturated polyester resin, an alkyd resin, or an epoxy resin; a polyamide resin, a polyester resin, a polyether resin, a methacrylic resin, an acrylic resin, a polyvinyl alcohol resin, and a polyvinyl acetal resin is particularly preferable.

In a case where these binder resins are used in combination of two or more kinds thereof, the mixing ratio thereof is set as necessary. In the present specification, the urethane resin obtained by a reaction between a resin and a curing agent will be referred to as “curing type urethane resin” for convenience.

### Inorganic Particles

The undercoat layer may further contain inorganic particles.

Examples of the inorganic particles include inorganic particles having a powder resistance (volume resistivity) of 10² Ω·cm or greater and 10¹¹ Ω·cm or less.

Among these, as the inorganic particles having the above-described resistance value, for example, metal oxide particles such as tin oxide particles, titanium oxide particles, zinc oxide particles, and zirconium oxide particles may be used, and zinc oxide particles are particularly preferable.

The specific surface area of the inorganic particles measured by the BET method may be, for example, 10 m²/g or greater. In a case where the specific surface area thereof is 10 m²/g or greater, degradation of the charging properties tends to be suppressed.

The volume average particle diameter of the inorganic particles may be, for example, 50 nm or greater and 2,000 nm or less (for example, preferably 60 nm or greater and 1,000 nm or less).

The content of the inorganic particles is, for example, preferably 0% by mass or greater and 80% by mass or less and more preferably 0% by mass or greater and 70% by mass or less with respect to the total solid content of the undercoat layer.

The inorganic particles may be subjected to a surface treatment. As the inorganic particles, inorganic particles subjected to different surface treatments or inorganic particles having different particle diameters may be used in the form of a mixture of two or more kinds thereof.

Examples of the surface treatment agent include a silane coupling agent, a titanate-based coupling agent, an aluminum-based coupling agent, and a surfactant. In particular, for example, a silane coupling agent is preferable, and a silane coupling agent containing an amino group is more preferable.

Examples of the silane coupling agent containing an amino group include 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane, but are not limited thereto.

The silane coupling agent may be used in the form of a mixture of two or more kinds thereof. For example, a silane coupling agent containing an amino group and another silane coupling agent may be used in combination. Examples of other silane coupling agents include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane, but are not limited thereto.

The surface treatment method using a surface treatment agent may be any method as long as the method is a known method, and any of a dry method or a wet method may be used.

The treatment amount of the surface treatment agent is, for example, preferably 0.5% by mass or greater and 10% by mass or less with respect to the amount of the inorganic particles.

The dry method is, for example, a method of attaching the surface treatment agent to the surface of the inorganic particles by directly adding the surface treatment agent to the inorganic particles or adding the surface treatment agent, which has been dissolved in an organic solvent, dropwise to the inorganic particles while stirring the inorganic particles with a mixer having a large shearing force and spraying the mixture together with dry air or nitrogen gas. The surface treatment agent may be added dropwise or sprayed, for example, at a temperature lower than or equal to the boiling point of the solvent. After the dropwise addition or the spraying of the surface treatment agent, the surface treatment agent may be further baked at 100° C. or higher. The baking is not particularly limited as long as the temperature and the time are adjusted such that the electrophotographic characteristics can be obtained.

The wet method is, for example, a method of attaching the surface treatment agent to the surface of inorganic particles by adding the surface treatment agent to the inorganic particles while dispersing the inorganic particles in a solvent by performing stirring or using ultrasonic waves, a sand mill, an attritor, or a ball mill, stirring or dispersing the mixture, and removing the solvent. The solvent removing method is carried out by, for example, filtration or distillation so that the solvent is distilled off. After removal of the solvent, the mixture may be further baked at 100° C. or higher. The baking is not particularly limited as long as the temperature and the time are adjusted such that the electrophotographic characteristics can be obtained. In the wet method, the moisture contained in the inorganic particles may be removed before the surface treatment agent is added, and examples thereof include a method of removing the moisture while stirring and heating the moisture in a solvent and a method of removing the moisture by azeotropically boiling the moisture with a solvent.

### Other Materials

The undercoat layer may further contain various additives for improving the electrical properties, the environmental stability, and the image quality.

Examples of the additives include known materials, for example, an electron-transporting pigment such as a polycyclic condensed pigment or an azo-based pigment, a zirconium chelate compound, a titanium chelate compound, an aluminum chelate compound, a titanium alkoxide compound, an organic titanium compound, and a silane coupling agent. The silane coupling agent is used for a surface treatment of the inorganic particles as described above, but may be further added to the undercoat layer as an additive.

Examples of the silane coupling agent serving as an additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compound include zirconium butoxide, ethyl zirconium acetoacetate, zirconium triethanolamine, acetylacetonate zirconium butoxide, ethyl zirconium butoxide acetoacetate, zirconium acetate, zirconium oxalate, zirconium lactate, zirconium phosphonate, zirconium octanoate, zirconium naphthenate, zirconium laurate, zirconium stearate, zirconium isostearate, zirconium butoxide methacrylate, stearate zirconium butoxide, and isostearate zirconium butoxide.

Examples of the titanium chelate compound include tetraisopropyl titanate, tetranormal butyl titanate, a butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanol aminate, and polyhydroxy titanium stearate.

Examples of the aluminum chelate compound include aluminum isopropylate, monobutoxyaluminum diisopropylate, aluminum butyrate, diethylacetoacetate aluminum diisopropylate, and aluminum tris(ethylacetoacetate).

These additives may be used alone or in the form of a mixture or a polycondensate of a plurality of compounds.

### Characteristics of Undercoat Layer

The full width at half maximum (FWHM) of the maximum intensity peak in the X-ray diffraction measurement performed in the thickness direction of the undercoat layer is 5.0° or less, for example, preferably 3.0° or less, more preferably 1.0° or less, and particularly preferably 0.7° or less.

In a case where the full width at half maximum (FWHM) of the maximum intensity peak is 5.0° or less, defects in the crystal structure are less, the crystals are regularly aligned, and as a result, electron transport properties are excellent.

A method of setting the full width at half maximum of the maximum intensity peak to be in the above-described ranges is not particularly limited, and examples thereof include a method of adjusting the full width at half maximum based on the average primary particle diameter, the aspect ratio, and the like of the electron transport material in the undercoat layer.

In a case where the relative integrated intensity of the maximum intensity peak in the X-ray diffraction spectrum obtained by measuring the undercoat layer in the thickness direction is defined as I₁ and the relative integrated intensity of the maximum intensity peak in the X-ray diffraction spectrum obtained by measuring the undercoat layer in a powder state with a volume average particle diameter of 5 μm or less is defined as I₂, the maximum value Nmax among alignment indices N represented by Equation (1) is, for example, preferably 1.0 or greater and 5.5 or less, more preferably 3.0 or greater and 5.3 or less, and still more preferably 4.0 or greater and 5.1 or less.

$$Alignment index = \frac{\frac{{I}_{1}}{\sum {I}_{1}}}{\frac{{I}_{2}}{\sum {I}_{2}}} \qquad ( 1 )$$

In the present disclosure, “maximum intensity peak” denotes the strongest crystal diffraction peak in the X-ray diffraction spectrum obtained by measuring the undercoat layer in a powder state with a volume average particle diameter of 5 μm or less.

In the present disclosure, the relative integrated intensity of the maximum intensity peak is obtained by integrating the value obtained by subtracting the intensity of the background from the intensity of the maximum intensity peak, and the subtraction of the intensity of the background is performed by the Shirley method.

For example, an alignment index N represented by Equation (1) in a certain maximum intensity peak A is a value obtained by dividing a value of the relative integrated intensity of a certain peak A/the relative integrated intensity of all peaks in the X-ray diffraction spectrum by a value of the relative integrated intensity of a certain maximum intensity peak A in the X-ray diffraction spectrum obtained by measuring the undercoat layer in a powder state with a volume average particle diameter of 5 μm or less/the relative integrated intensity value of all peaks in the X-ray diffraction spectrum obtained by measuring the undercoat layer in a powder state with a volume average particle diameter of 5 μm or less.

Among the alignment indices N represented by Equation (1) determined in each peak, the largest value is a value of Nmax.

Further, it is assumed that the undercoat layer in a powder state with a volume average particle diameter of 5 μm or less is formed that the alignment state of crystals is random. Therefore, it is assumed that in a case where the value of the maximum value Nmax among the alignment indices N represented by Equation (1) is 5.5 or less, that is, the value of the maximum value Nmax is relative smaller, the alignment of crystals in the undercoat layer is small and the arrangement of the electron transport material of the undercoat layer in the crystal direction is random.

In the present disclosure, the full width at half maximum (FWHM) of the maximum intensity peak and the value of the maximum value Nmax among the alignment indices N are determined by X-ray diffraction measurement under the measurement conditions.
Measuring device: D8 DISCOVER, manufactured by Bruker AXS
X-ray source: CuKα
Measuring method: 2θ/θ scan

However, Cr, Fe, Co, and Mo may be used as the X-ray source in addition to CuKα, and the measurement range is required to set a range where all diffraction peaks derived from the electron-transporting compound in a powder state can be detected.

As a method of forming the undercoat layer in a powder state with a volume average particle diameter of 5 μm or less, any method such as a method of pulverizing the undercoat layer by using a ball mill, a bead mill, a mortar, a sand mill, a kneader, an attritor, or the like or a method of dissolving the undercoat layer in fluoroacetic acid, sulfuric acid, or the like and bringing the solution into contact with water or a poor solvent so that microcrystals are precipitated may be used. Further, any of a dry method or a wet method can be used as the conditions for the pulverization treatment. For example, it is preferable to use an inorganic compound such as a common salt or mirabilite or a grinding medium such as glass beads, steel beads, alumina beads, or zirconia beads during the pulverization from the viewpoint of easily obtaining the uniformity of crystals. In a case of the wet method, any treatment solvent such as water, alcohol, or an organic solvent can be used for the purpose of further controlling the crystal shape and the size of the particles.

A method of setting the value of the maximum value Nmax to be in the above-described ranges is not particularly limited, and examples thereof include a method of adjusting the value based on the average primary particle diameter, the aspect ratio, and the like of the electron transport material in the undercoat layer.

The undercoat layer has, for example, a LUMO energy level of preferably 3.8 eV or greater and 4.2 eV or less, more preferably 3.9 eV or greater and 4.2 eV or less, and still more preferably 4.0 eV or greater and 4.2 eV or less.

In a case where the LUMO energy level of the undercoat layer is 4.2 eV or less, the charge maintainability is more excellent. Meanwhile, in a case where the LUMO energy level of the undercoat layer is 3.8 eV or greater, the electron injection properties from the charge generation layer are more excellent.

A method of setting the LUMO energy level of the undercoat layer to be in the above-described ranges is not particularly limited, and examples thereof include a method of adjusting the kind of the electron transport material (for example, more preferably setting the electron transport material as in the specification containing at least one of the electron transport material represented by General Formula (P) or the electron transport material represented by General Formula (Q).

The LUMO energy level of the undercoat layer is determined in the following manner.

The electrophotographic photoreceptor is cut into a size of 2 cm square from a side of the outer peripheral surface in the lamination direction, and the photosensitive layer is removed using a solvent such as THE to prepare a sample formed of only the conductive substrate and the undercoat layer. The prepared sample is measured from the side of the outer peripheral surface (that is, from the side of the undercoat layer) of the electrophotographic photoreceptor in an energy level range of 4 eV to 6.2 eV at a wavelength of 500 nm using an atmospheric photoelectron yield spectrometer AC-2 (manufactured by Institute of Physical and Chemical Research) to obtain a spectral graph in which the horizontal axis represents the energy of irradiation light and the vertical axis represents an electron coefficient ratio. In this spectral graph, an intersection between a base line and a straight line drawn at the rising portion of the plot from the base line is defined as E_{HOMO}. Subsequently, the single film of the undercoat layer peeled off from the base material is measured in a wavelength range of 200 nm or greater and 800 nm or less by a transmission method using an ultraviolet-visible near-infrared (UV-Vis-NIR) spectrophotometer (model number: Cary 5000, manufactured by Agilent Technologies, Inc.), and the absorption edge in a wavelength range of 400 nm or greater and 700 nm or less is calculated to determine an energy gap (HOMO−LUMO=energy gap ΔE). The LUMO is determined according to the following equation.

$$LUMO = HOMO - Δ E \qquad Equation$$

The volume resistivity of the undercoat layer is, for example, preferably 1×10¹⁰ Ω·cm or greater and 1×10¹² Ω·cm or less.

The undercoat layer may have, for example, a Vickers hardness of 35 or greater. The surface roughness (ten-point average roughness) of the undercoat layer may be adjusted, for example, to ½ from 1/(4n) (n represents a refractive index of an upper layer) of a laser wavelength λ for exposure to be used to suppress moire fringes.

Resin particles or the like may be added to the undercoat layer to adjust the surface roughness. Examples of the resin particles include silicone resin particles and crosslinked polymethyl methacrylate resin particles. Further, the surface of the undercoat layer may be polished to adjust the surface roughness. Examples of the polishing method include buff polishing, a sandblast treatment, wet honing, and a grinding treatment.

### Method of Forming Undercoat Layer

The formation of the undercoat layer is not particularly limited, and a known forming method is used. For example, a coating film of a coating solution for forming an undercoat layer in which the above-described components are added to a solvent is formed, and the coating film is dried and, as necessary, heated.

Examples of the solvent for preparing the coating solution for forming an undercoat layer include known organic solvents such as an alcohol-based solvent, an aromatic hydrocarbon solvent, a halogenated hydrocarbon solvent, a ketone-based solvent, a ketone alcohol-based solvent, an ether-based solvent, and an ester-based solvent.

Specific examples of these solvents include typical organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method of dispersing the inorganic particles when preparing the coating solution for forming an undercoat layer include known methods such as a roll mill, a ball mill, a vibration ball mill, an attritor, a sand mill, a colloid mill, and a paint shaker.

Since the electron transport material (particularly, the electron transport material represented by General Formula (P)) is unlikely to be dissolved in an organic solvent, for example, it is desirable that the electron transport material is dispersed in an organic solvent. Examples of a dispersing method include known methods such as a roll mill, a ball mill, a vibration ball mill, an attritor, a sand mill, a colloid mill, and a paint shaker. In a case where the metal oxide particles are blended into the undercoat layer, for example, it is desirable that the metal oxide particles are dispersed in an organic solvent by the same dispersing method.

Examples of the method of coating the conductive substrate with the coating solution for forming an undercoat layer include typical methods such as a blade coating method, a wire bar coating method, a spray coating method, a dip coating method, a bead coating method, an air knife coating method, and a curtain coating method.

The content of the metal oxide in the undercoat layer is, for example, preferably 5% by mass or less, more preferably 3% by mass or less, and still more preferably 0% by mass (that is, the undercoat layer contains no metal oxide) or 2% by mass or less with respect to the total solid content of the undercoat layer.

In general, the metal oxide tends to have low resistance. Therefore, in a case where the content of the metal oxide in the undercoat layer is 5% by mass or less, degradation of the electron transport properties and the charge maintainability due to a decrease in the resistance of the undercoat layer is suppressed. Further, from the viewpoint of production aiming at reducing the environmental load, for example, it is preferable that the content of the metal oxide is decreased.

The thickness of the undercoat layer is, for example, preferably 5 μm or greater and 15 μm or less, more preferably 7 μm or greater and 14 μm or less, and still more preferably 8 μm or greater and 13 μm or less.

The thickness of the undercoat layer may be 15 μm or greater or 20 μm or greater and 50 μm or less.

Since the electron transport material of the related art slightly has positive hole transport properties in addition to the electron transport properties, image defects caused by injection of the charges to the photosensitive layer from the conductive substrate so that the charges on the surface are reduced are suppressed by reducing the film thickness of the undercoat layer (for example, setting the film thickness to 5 μm or less). However, in a case where the film thickness of the undercoat layer is small, for example, in a case where needle-like foreign matter is mixed from a developing unit (for example, a developing machine) or a transfer unit (for example, an intermediate transfer member) during the image formation, since the needle-like foreign matter is stuck into a region from the surface of the electrophotographic photoreceptor to the undercoat layer, the charge maintainability is degraded due to the leakage current in some cases. Meanwhile, in the present exemplary embodiment, since the undercoat layer contains the electron transport material represented by General Formula (P), which has excellent electron transport properties and low positive hole transport properties, the film thickness can be set to be larger (for example, set to 5 μm or greater) than the film thickness of an undercoat layer of the related art. Therefore, it is considered that even in a case where needle-like foreign matter is stuck into a region from the surface of the electrophotographic photoreceptor to the undercoat layer, the leakage current is unlikely to occur, and thus the charge maintainability is excellent.

In a case where the thickness of the undercoat layer is 15 μm or less, the leakage current occurs in the bulk, the amount of charge remaining in the undercoat layer is increased, and therefore, an increase in dark decay is suppressed. As a result, it is considered that the charge maintainability is more excellent.

### Conductive Substrate

Examples of the conductive substrate include metal plates containing metals (such as aluminum, copper, zinc, chromium, nickel, molybdenum, vanadium, indium, gold, and platinum) or alloys (such as stainless steel), metal drums, metal belts, and the like. Further, examples of the conductive substrate include paper, a resin film, a belt, and the like obtained by being coated, vapor-deposited or laminated with a conductive compound (such as a conductive polymer or indium oxide), a metal (such as aluminum, palladium, or gold) or an alloy. Here, the term “conductive” denotes that the volume resistivity is less than 10¹³ Ω·cm.

In a case where the electrophotographic photoreceptor is used in a laser printer, for example, it is preferable that the surface of the conductive substrate is roughened such that a centerline average roughness Ra thereof is 0.04 μm or greater and 0.5 μm or less for the purpose of suppressing interference fringes from occurring in a case of irradiation with laser beams. Further, in a case where incoherent light is used as a light source, roughening of the surface to prevent interference fringes is not particularly necessary, and it is appropriate for longer life because occurrence of defects due to the roughness of the surface of the conductive substrate is suppressed.

Examples of the roughening method include wet honing performed by suspending an abrasive in water and spraying the suspension to the conductive substrate, centerless grinding performed by pressure-welding the conductive substrate against a rotating grindstone and continuously grinding the conductive substrate, and an anodizing treatment.

Examples of the roughening method also include a method of dispersing conductive or semi-conductive powder in a resin without roughening the surface of the conductive substrate to form a layer on the surface of the conductive substrate, and performing roughening using the particles dispersed in the layer.

The roughening treatment performed by anodization is a treatment of forming an oxide film on the surface of the conductive substrate by carrying out anodization in an electrolytic solution using a conductive substrate made of a metal (for example, aluminum) as an anode. Examples of the electrolytic solution include a sulfuric acid solution and an oxalic acid solution. However, a porous anodized film formed by anodization is chemically active in a natural state, is easily contaminated, and has a large resistance fluctuation depending on the environment. Therefore, for example, it is preferable that a sealing treatment is performed on the porous anodized film so that the micropores of the oxide film are closed by volume expansion due to a hydration reaction in pressurized steam or boiling water (a metal salt such as nickel may be added thereto) for a change into a more stable a hydrous oxide.

The film thickness of the anodized film is, for example, preferably 0.3 μm or greater and 15 μm or less. In a case where the film thickness is in the above-described range, the barrier properties against injection tend to be exhibited, and an increase in the residual potential due to repeated use tends to be suppressed.

The conductive substrate may be subjected to a treatment with an acidic treatment liquid or a boehmite treatment.

The treatment with an acidic treatment liquid is carried out, for example, as follows. First, an acidic treatment liquid containing phosphoric acid, chromic acid, and hydrofluoric acid is prepared. In the blending ratio of phosphoric acid, chromic acid, and hydrofluoric acid in the acidic treatment liquid, for example, the concentration of the phosphoric acid is 10% by mass or greater and 11% by mass or less, the concentration of the chromic acid is 3% by mass or greater and 5% by mass or less, and the concentration of the hydrofluoric acid is 0.5% by mass or greater and 2% by mass or less, and the concentration of all these acids may be, for example, 13.5% by mass or greater and 18% by mass or less. The treatment temperature is, for example, preferably 42° C. or higher and 48° C. or lower. The film thickness of the coating film is, for example, preferably 0.3 μm or greater and 15 μm or less.

The boehmite treatment is carried out, for example, by dipping the conductive substrate in pure water at 90° C. or higher and 100° C. or lower for 5 minutes to 60 minutes or by bringing the conductive substrate into contact with heated steam at 90° C. or higher and 120° C. or lower for 5 minutes to 60 minutes. The film thickness of the coating film is, for example, preferably 0.1 μm or greater and 5 μm or less. This coating film may be further subjected to the anodizing treatment using an electrolytic solution having low film solubility, such as adipic acid, boric acid, a borate, a phosphate, a phthalate, a maleate, a benzoate, a tartrate, or a citrate.

### Interlayer

Although not shown in the figures, an interlayer may be further provided between the undercoat layer and the photosensitive layer.

The interlayer is, for example, a layer containing a resin. Examples of the resin used for the interlayer include a polymer compound, for example, an acetal resin (such as polyvinyl butyral), a polyvinyl alcohol resin, a polyvinyl acetal resin, a casein resin, a polyamide resin, a cellulose resin, gelatin, a polyurethane resin, a polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a phenol-formaldehyde resin, or a melamine resin.

The interlayer may be a layer containing an organometallic compound. Examples of the organometallic compound used for the interlayer include an organometallic compound containing metal atoms such as zirconium, titanium, aluminum, manganese, and silicon.

The compounds used for the interlayer may be used alone or in the form of a mixture or a polycondensate of a plurality of compounds.

Among these, it is preferable that the interlayer is, for example, a layer containing an organometallic compound having a zirconium atom or a silicon atom.

The formation of the interlayer is not particularly limited, and a known forming method is used. For example, a coating film of a coating solution for forming an interlayer in which the above-described components are added to a solvent is formed, and the coating film is dried and, as necessary, heated.

Examples of the coating method of forming the interlayer include typical methods such as a dip coating method, a push-up coating method, a wire bar coating method, a spray coating method, a blade coating method, an air knife coating method, and a curtain coating method.

The film thickness of the interlayer is set to be, for example, preferably in a range of 0.1 μm or greater and 3 μm or less. Further, the interlayer may be used as the undercoat layer.

### Charge Generation Layer

The charge generation layer is, for example, a layer containing a charge generation material and a binder resin. Further, the charge generation layer may be a deposition layer of the charge generation material. The deposition layer of the charge generation material is, for example, preferable in a case where an incoherent light source such as a light emitting diode (LED) or an organic electro-luminescence (EL) image array is used.

Examples of the charge generation material include an azo pigment such as bisazo or trisazo; a fused ring aromatic pigment such as dibromoanthanthrone; a perylene pigment; a pyrrolopyrrole pigment; a phthalocyanine pigment; zinc oxide; and trigonal selenium.

Among these, for example, a metal phthalocyanine pigment or a metal-free phthalocyanine pigment is preferably used as the charge generation material in order to deal with laser exposure in a near infrared region. Specifically, for example, hydroxygallium phthalocyanine; chlorogallium phthalocyanine; dichloro-tin phthalocyanine; and titanyl phthalocyanine are more preferable.

On the other hand, for example, a fused ring aromatic pigment such as dibromoanthanthrone; a thioindigo-based pigment; a porphyrazine compound; zinc oxide; trigonal selenium; or a bisazo pigment is preferable as the charge generation material in order to deal with laser exposure in a near ultraviolet region.

The above-described charge generation material may also be used even in a case where an incoherent light source such as an LED or an organic EL image array having a center wavelength of light emission at 450 nm or greater and 780 nm or less is used, but from the viewpoint of the resolution, the electric field intensity in the photosensitive layer is increased, and a decrease in charge due to injection of the charge from the substrate, that is, image defects referred to as so-called black spots are likely to occur in a case where a thin film having a thickness of 20 μm or less is used as the photosensitive layer. The above-described tendency is evident in a case where a p-type semiconductor such as trigonal selenium or a phthalocyanine pigment is used as the charge generation material that is likely to generate a dark current.

Meanwhile, in a case where an n-type semiconductor such as a fused ring aromatic pigment, a perylene pigment, or an azo pigment is used as the charge generation material, a dark current is unlikely to be generated, and image defects referred to as black spots can be suppressed even in a case where a thin film is used as the photosensitive layer.

Further, the n-type is determined by the polarity of the flowing photocurrent using a typically used time-of-flight method, and a material in which electrons more easily flow as carriers than positive holes is determined as the n-type.

The binder resin used for the charge generation layer is selected from a wide range of insulating resins, and the binder resin may be selected from organic photoconductive polymers such as poly-N-vinylcarbazole, polyvinylanthracene, polyvinylpyrene, and polysilane.

Examples of the binder resin include a polyvinyl butyral resin, a polyarylate resin (a polycondensate of bisphenols and aromatic divalent carboxylic acid), a polycarbonate resin, a polyester resin, a phenoxy resin, a vinyl chloride-vinyl acetate copolymer, a polyamide resin, an acrylic resin, a polyacrylamide resin, a polyvinylpyridine resin, a cellulose resin, a urethane resin, an epoxy resin, casein, a polyvinyl alcohol resin, and a polyvinylpyrrolidone resin. Here, the term “insulating” denotes that the volume resistivity is 10¹³ Ω·cm or greater.

These binder resins may be used alone or in the form of a mixture of two or more kinds thereof.

Further, the blending ratio between the charge generation material and the binder resin is, for example, preferably in a range of 10:1 to 1:10 in terms of the mass ratio.

The charge generation layer may also contain other known additives.

The formation of the charge generation layer is not particularly limited, and a known forming method is used. For example, a coating film of a coating solution for forming a charge generation layer in which the above-described components are added to a solvent is formed, and the coating film is dried and, as necessary, heated. Further, the charge generation layer may be formed by vapor deposition of the charge generation material. The formation of the charge generation layer by vapor deposition is, for example, particularly appropriate in a case where a fused ring aromatic pigment or a perylene pigment is used as the charge generation material.

Examples of the solvent for preparing the coating solution for forming a charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These solvents are used alone or in the form of a mixture of two or more kinds thereof.

As a method of dispersing particles (for example, the charge generation material) in the coating solution for forming a charge generation layer, for example, a media disperser such as a ball mill, a vibration ball mill, an attritor, a sand mill, or a horizontal sand mill, or a medialess disperser such as a stirrer, an ultrasonic disperser, a roll mill, or a high-pressure homogenizer is used. Examples of the high-pressure homogenizer include a collision type high-pressure homogenizer in which a dispersion liquid is dispersed by a liquid-liquid collision or a liquid-wall collision in a high-pressure state, and a penetration type high-pressure homogenizer in which a dispersion liquid is dispersed by causing the dispersion liquid to penetrate through a micro-flow path in a high-pressure state.

During the dispersion, it is effective to set the average particle diameter of the charge generation material in the coating solution for forming a charge generation layer to 0.5 μm or less, for example, preferably 0.3 μm or less, and more preferably 0.15 μm or less.

Examples of the method of coating the undercoat layer (or the interlayer) with the coating solution for forming a charge generation layer include typical methods such as a blade coating method, a wire bar coating method, a spray coating method, a dip coating method, a bead coating method, an air knife coating method, and a curtain coating method.

The film thickness of the charge generation layer is set to be, for example, preferably in a range of 0.1 μm or greater and 5.0 μm or less and more preferably in a range of 0.2 μm or greater and 2.0 μm or less.

### Charge Transport Layer

The charge transport layer is, for example, a layer containing a charge transport material and a binder resin. The charge transport layer may be a layer containing a polymer charge transport material.

Examples of the charge transport material include a quinone-based compound such as p-benzoquinone, chloranil, bromanil, or anthraquinone; a tetracyanoquinodimethane-based compound; a fluorenone compound such as 2,4,7-trinitrofluorenone; a xanthone-based compound; a benzophenone-based compound; a cyanovinyl-based compound; and an electron-transporting compound such as an ethylene-based compound. Examples of the charge transport material include a positive hole-transporting compound such as a triarylamine-based compound, a benzidine-based compound, an arylalkane-based compound, an aryl-substituted ethylene-based compound, a stilbene-based compound, an anthracene-based compound, or a hydrazone-based compound. These charge transport materials may be used alone or in combination of two or more kinds thereof, but are not limited thereto.

From the viewpoint of the charge mobility, for example, a triarylamine derivative represented by Structural Formula (a-1) or a benzidine derivative represented by Structural Formula (a-2) is preferable as the charge transport material.

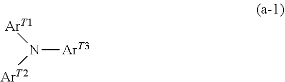

In Structural Formula (a-1), Ar^{T1}, Ar^{T2}, and Ar^{T3} each independently represent a substituted or unsubstituted aryl group, —C₆H₄—C(R^{T4})═C(R^{T5})(R^{T6}), or —C₆H₄—CH═CH—CH═C(R^{T7})(R^{T8}). R^{T4}, R^{T5}, R^{T6}, R^{T7}, and R^{T8} each independently represent a hydrogen atom, a substituted or unsubstituted alkyl group, or a substituted or unsubstituted aryl group.

Examples of the substituent of each group described above include a halogen atom, an alkyl group having 1 or more and 5 or less carbon atoms, and an alkoxy group having 1 or more and 5 or less carbon atoms. Further, examples of the substituent of each group described above include a substituted amino group substituted with an alkyl group having 1 or more and 3 or less carbon atoms.

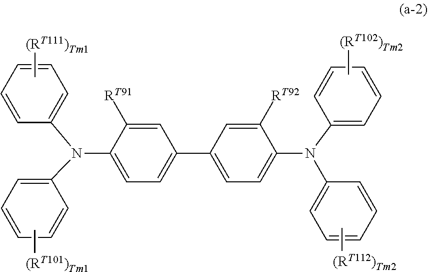

In Structural Formula (a-2), R^{T91} and R^{T92} each independently represent a hydrogen atom, a halogen atom, an alkyl group having 1 or more and 5 or less carbon atoms, or an alkoxy group having 1 or more and 5 or less carbon atoms. R^{T10}, R^{T102}, R^{T111}, and R^{T112} each independently represent a halogen atom, an alkyl group having 1 or more and 5 or less carbon atoms, an alkoxy group having 1 or more and 5 or less carbon atoms, an amino group substituted with an alkyl group having 1 or more and 2 or less carbon atoms, a substituted or unsubstituted aryl group, —C(R^{T12})═C(R^{T13})(R^{T14}), or —CH═CH—CH═C(R^{T15})(R^{T16}), and R^{T12}, R^{T13}, R^{T14}, R^{T15}, and R^{T16} each independently represent a hydrogen atom, a substituted or unsubstituted alkyl group, or a substituted or unsubstituted aryl group. Tm1, Tm2, Tn1, and Tn2 each independently represent an integer of 0 or greater and 2 or less.

Examples of the substituent of each group described above include a halogen atom, an alkyl group having 1 or more and 5 or less carbon atoms, and an alkoxy group having 1 or more and 5 or less carbon atoms. Further, examples of the substituent of each group described above include a substituted amino group substituted with an alkyl group having 1 or more and 3 or less carbon atoms.

Here, among the triarylamine derivative represented by Structural Formula (a-1) and the benzidine derivative represented by Structural Formula (a-2), for example, a triarylamine derivative having “—C₆H₄—CH═CH—CH═C(R^{T7})(R^{T8})” and a benzidine derivative having “—CH═CH—CH═C(R^{T15})(R^{T16})” are particularly preferable from the viewpoint of the charge mobility.

As the polymer charge transport material, known materials having charge transport properties, such as poly-N-vinylcarbazole and polysilane, can be used. Particularly, for example, a polyester-based polymer charge transport material is particularly preferable. Further, the polymer charge transport material may be used alone or in combination of binder resins.

Examples of the binder resin used for the charge transport layer include a polycarbonate resin, a polyester resin, a polyarylate resin, a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone alkyd resin, a phenol-formaldehyde resin, a styrene-alkyd resin, poly-N-vinylcarbazole, and polysilane. Among these, for example, a polycarbonate resin or a polyarylate resin is preferable as the binder resin. These binder resins may be used alone or in combination of two or more kinds thereof.

Further, the blending ratio between the charge transport material and the binder resin is, for example, preferably in a range of 10:1 to 1:5 in terms of the mass ratio.

The charge transport layer may also contain other known additives.

The formation of the charge transport layer is not particularly limited, and a known forming method is used. For example, a coating film of a coating solution for forming a charge transport layer in which the above-described components are added to a solvent is formed, and the coating film is dried and, as necessary, heated.

Examples of the solvent for preparing the coating solution for forming a charge transport layer include typical organic solvents, for example, aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. These solvents are used alone or in the form of a mixture of two or more kinds thereof.

Examples of the coating method of coating the charge generation layer with the coating solution for forming a charge transport layer include typical methods such as a blade coating method, a wire bar coating method, a spray coating method, a dip coating method, a bead coating method, an air knife coating method, and a curtain coating method.

The film thickness of the charge transport layer is set to be, for example, preferably in a range of 5 μm or greater and 50 μm or less and more preferably in a range of 10 μm or greater and 30 μm or less.

### Protective Layer

A protective layer is provided on the photosensitive layer as necessary. The protective layer is provided, for example, for the purpose of preventing a chemical change in the photosensitive layer during charging and further improving the mechanical strength of the photosensitive layer.

Therefore, for example, a layer formed of a cured film (crosslinked film) may be applied to the protective layer. Examples of these layers include the layers described in the items 1) and 2) below.

1) A layer formed of a cured film with a composition containing a reactive group-containing charge transport material having a reactive group and a charge-transporting skeleton in an identical molecule (that is, a layer containing a polymer or a crosslinked body of the reactive group-containing charge transport material)

2) A layer formed of a cured film with a composition containing a non-reactive charge transport material and a reactive group-containing non-charge transport material containing a reactive group without having a charge-transporting skeleton (that is, a layer containing the non-reactive charge transport material and a polymer or crosslinked body of the reactive group-containing non-charge transport material)

Examples of the reactive group of the reactive group-containing charge transport material include known reactive groups such as a chain polymerizable group, an epoxy group, —OH, —OR [here, R represents an alkyl group], —NH₂, —SH, —COOH, and —SiRQ_{3-Qn}(OR^{Q2})_{Qn} [here, R^{Q1} represents a hydrogen atom, an alkyl group, or a substituted or unsubstituted aryl group, R^{Q2} represents a hydrogen atom, an alkyl group, or a trialkylsilyl group, and Qn represents an integer of 1 to 3].

The chain polymerizable group is not particularly limited as long as the group is a functional group capable of radical polymerization and is, for example, a functional group containing a group having at least a carbon double bond. Specific examples thereof include a vinyl group, a vinyl ether group, a vinyl thioether group, a styryl group (vinylphenyl group), an acryloyl group, a methacryloyl group, and a group containing at least one selected from derivatives thereof. Among these, from the viewpoint that the reactivity is excellent, for example, a vinyl group, a styryl group (vinylphenyl group), an acryloyl group, a methacryloyl group, and a group containing at least one selected from derivatives thereof are preferable as the chain polymerizable group.

The charge-transporting skeleton of the reactive group-containing charge transport material is not particularly limited as long as the skeleton is a known structure in the electrophotographic photoreceptor, and examples thereof include a structure conjugated with a nitrogen atom, which is a skeleton derived from a nitrogen-containing positive hole-transporting compound such as a triarylamine-based compound, a benzidine-based compound, or a hydrazone-based compound. Among these, for example, a triarylamine skeleton is preferable.

The reactive group-containing charge transport material having the reactive group and the charge-transporting skeleton, the non-reactive charge transport material, and the reactive group-containing non-charge transport material may be selected from known materials.

The protective layer may also contain other known additives.

The formation of the protective layer is not particularly limited, and a known forming method is used. For example, a coating film of a coating solution for forming a protective layer in which the above-described components are added to a solvent is formed, and the coating film is dried and, as necessary, subjected to a curing treatment such as heating.

Examples of the solvent for preparing the coating solution for forming a protective layer include an aromatic solvent such as toluene or xylene; a ketone-based solvent such as methyl ethyl ketone, methyl isobutyl ketone, or cyclohexanone; an ester-based solvent such as ethyl acetate or butyl acetate; an ether-based solvent such as tetrahydrofuran or dioxane; a cellosolve-based solvent such as ethylene glycol monomethyl ether; and an alcohol-based solvent such as isopropyl alcohol or butanol. These solvents are used alone or in the form of a mixture of two or more kinds thereof.

In addition, the coating solution for forming a protective layer may be a solvent-less coating solution.

Examples of the method of coating the photosensitive layer (such as the charge transport layer) with the coating solution for forming a protective layer include typical methods such as a dip coating method, a push-up coating method, a wire bar coating method, a spray coating method, a blade coating method, an air knife coating method, and a curtain coating method.

The film thickness of the protective layer is set to be, for example, preferably in a range of 1 μm or greater and 20 μm or less and more preferably in a range of 2 μm or greater and 10 μm or less.

### Single Layer Type Photosensitive Layer

The single layer type photosensitive layer (charge generation/charge transport layer) is a layer containing a charge generation material, a charge transport material, a binder resin, and as necessary, other known additives. Further, these materials are the same as the materials described in the sections of the charge generation layer and the charge transport layer.

Further, the content of the charge generation material in the single layer type photosensitive layer may be, for example, 0.1% by mass or greater and 10% by mass or less and preferably 0.8% by mass or greater and 5% by mass or less with respect to the total solid content. Further, the content of the charge transport material in the single layer type photosensitive layer may be, for example, 5% by mass or greater and 50% by mass or less with respect to the total solid content.

The method of forming the single layer type photosensitive layer is the same as the method of forming the charge generation layer or the charge transport layer.

The film thickness of the single layer type photosensitive layer may be, for example, 5 m or greater and 50 μm or less and preferably 10 μm or greater and 40 μm or less.

### Image Forming Apparatus and Process Cartridge

An image forming apparatus according to the present exemplary embodiment includes the electrophotographic photoreceptor, a charging device that charges a surface of the electrophotographic photoreceptor, an electrostatic latent image forming device that forms an electrostatic latent image on the charged surface of the electrophotographic photoreceptor, a developing device that develops the electrostatic latent image formed on the surface of the electrophotographic photoreceptor with a developer containing a toner to form a toner image, and a transfer device that transfers the toner image to a surface of a recording medium. Further, the electrophotographic photoreceptor according to the present exemplary embodiment is employed as the electrophotographic photoreceptor.

As the image forming apparatus according to the present exemplary embodiment, known image forming apparatuses such as an apparatus including a fixing device that fixes a toner image transferred to the surface of a recording medium; a direct transfer type apparatus that transfers a toner image formed on the surface of an electrophotographic photoreceptor directly to a recording medium; an intermediate transfer type apparatus that primarily transfers a toner image formed on the surface of an electrophotographic photoreceptor to the surface of an intermediate transfer member and secondarily transfers the toner image transferred to the surface of the intermediate transfer member to the surface of a recording medium; an apparatus including a cleaning device that cleans the surface of an electrophotographic photoreceptor after the transfer of a toner image and before the charging; an apparatus including a charge erasing device that erases the charges on the surface of an electrophotographic photoreceptor by applying the charge erasing light after the transfer of a toner image and before the charging; and an apparatus including an electrophotographic photoreceptor heating member for increasing the temperature of an electrophotographic photoreceptor and decreasing the relative temperature are employed.

In a case of the intermediate transfer type apparatus, the transfer device is, for example, configured to include an intermediate transfer member having a surface onto which the toner image is transferred, a primary transfer device primarily transferring the toner image formed on the surface of the electrophotographic photoreceptor to the surface of the intermediate transfer member, and a secondary transfer device secondarily transferring the toner image transferred to the surface of the intermediate transfer member to the surface of the recording medium.

The image forming apparatus according to the present exemplary embodiment may be any of a dry development type image forming apparatus or a wet development type (development type using a liquid developer) image forming apparatus.

Further, in the image forming apparatus according to the present exemplary embodiment, for example, the portion including the electrophotographic photoreceptor may have a cartridge structure (process cartridge) that is attachable to and detachable from the image forming apparatus. As the process cartridge, for example, a process cartridge including the electrophotographic photoreceptor according to the present exemplary embodiment is preferably used. Further, the process cartridge may include, for example, at least one selected from the group consisting of a charging device, an electrostatic latent image forming device, a developing device, and a transfer device in addition to the electrophotographic photoreceptor.

Hereinafter, an example of the image forming apparatus according to the present exemplary embodiment will be described, but the present exemplary embodiment is not limited thereto. Further, main parts shown in the figures will be described, but description of other parts will not be provided.

FIG. 2 is a schematic configuration view showing an example of the image forming apparatus according to the present exemplary embodiment.

As shown in FIG. 2, an image forming apparatus 100 according to the present exemplary embodiment includes a process cartridge 300 including an electrophotographic photoreceptor 7, an exposure device 9 (an example of an electrostatic latent image forming device), a transfer device 40 (primary transfer device), and an intermediate transfer member 50. Further, in the image forming apparatus 100, the exposure device 9 is disposed at a position that can be exposed to the electrophotographic photoreceptor 7 from an opening portion of the process cartridge 300, the transfer device 40 is disposed at a position that faces the electrophotographic photoreceptor 7 via the intermediate transfer member 50, and the intermediate transfer member 50 is disposed such that a part of the intermediate transfer member 50 is in contact with the electrophotographic photoreceptor 7. Although not shown, the image forming apparatus also includes a secondary transfer device that transfers the toner image transferred to the intermediate transfer member 50 to a recording medium (for example, paper). Further, the intermediate transfer member 50, the transfer device 40 (primary transfer device), and the secondary transfer device (not shown) correspond to an example of the transfer device.

The process cartridge 300 in FIG. 2 integrally supports the electrophotographic photoreceptor 7, a charging device 8 (an example of the charging device), a developing device 11 (an example of the developing device), and a cleaning device 13 (an example of the cleaning device) in a housing. The cleaning device 13 has a cleaning blade (an example of the cleaning member) 131, and the cleaning blade 131 is disposed to come into contact with the surface of the electrophotographic photoreceptor 7. Further, the cleaning member may be a conductive or insulating fibrous member instead of the aspect of the cleaning blade 131, and may be used alone or in combination with the cleaning blade 131.

Further, FIG. 2 shows an example of an image forming apparatus including a fibrous member 132 (roll shape) that supplies a lubricant 14 to the surface of the electrophotographic photoreceptor 7 and a fibrous member 133 (flat brush shape) that assists cleaning, but these are disposed as necessary.

Hereinafter, each configuration of the image forming apparatus according to the present exemplary embodiment will be described.

### Charging Device

As the charging device 8, for example, a contact type charger formed of a conductive or semi-conductive charging roller, a charging brush, a charging film, a charging rubber blade, a charging tube, or the like is used. Further, a known charger such as a non-contact type roller charger, or a scorotron charger or a corotron charger using corona discharge is also used.

### Exposure Device

Examples of the exposure device 9 include an optical system device that exposes the surface of the electrophotographic photoreceptor 7 to light such as a semiconductor laser beam, LED light, and liquid crystal shutter light in a predetermined image pattern. The wavelength of the light source is within the spectral sensitivity region of the electrophotographic photoreceptor. As the wavelength of a semiconductor laser, near infrared, which has an oscillation wavelength in the vicinity of 780 nm, is mostly used. However, the wavelength is not limited thereto, and a laser having an oscillation wavelength of an approximately 600 nm level or a laser having an oscillation wavelength of 400 nm or greater and 450 nm or less as a blue laser may also be used. Further, a surface emission type laser light source capable of outputting a multi-beam is also effective for forming a color image.

### Developing Device

Examples of the developing device 11 include a typical developing device that performs development in contact or non-contact with the developer. The developing device 11 is not particularly limited as long as the developing device has the above-described functions, and is selected depending on the purpose thereof. Examples of the developing device include known developing machines having a function of attaching a one-component developer or a two-component developer to the electrophotographic photoreceptor 7 using a brush, a roller, or the like. Among these, for example, a developing device formed of a developing roller having a surface on which a developer is held is preferably used.

The developer used in the developing device 11 may be a one-component developer containing only a toner or a two-component developer containing a toner and a carrier. Further, the developer may be magnetic or non-magnetic. Known developers are employed as these developers.

### Cleaning Device

As the cleaning device 13, a cleaning blade type device including the cleaning blade 131 is used.

In addition to the cleaning blade type device, a fur brush cleaning type device or a simultaneous development cleaning type device may be employed.

### Transfer Device

Examples of the transfer device 40 include a known transfer charger such as a contact type transfer charger using a belt, a roller, a film, a rubber blade, or the like, or a scorotron transfer charger or a corotron transfer charger using corona discharge.

### Intermediate Transfer Member

As the intermediate transfer member 50, a belt-like intermediate transfer member (intermediate transfer belt) containing semi-conductive polyimide, polyamide-imide, polycarbonate, polyarylate, polyester, rubber, or the like is used. Further, as the form of the intermediate transfer member, a drum-like intermediate transfer member may be used in addition to the belt-like intermediate transfer member.

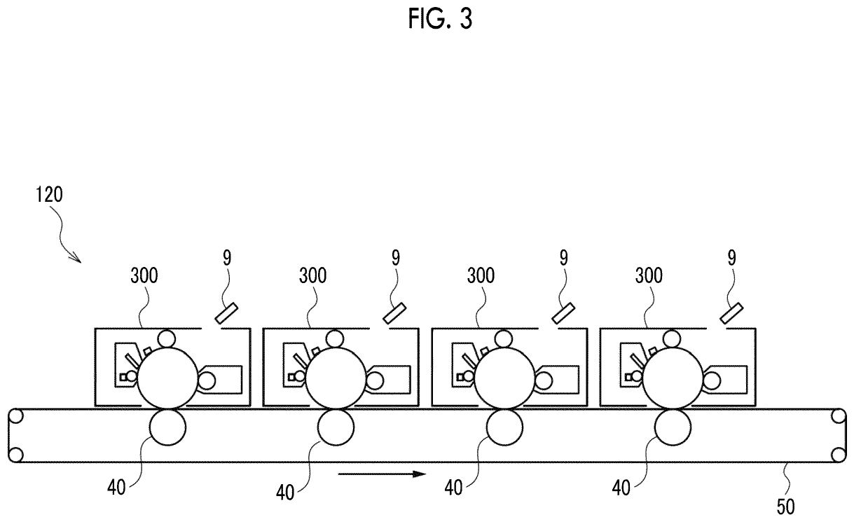

FIG. 3 is a schematic configuration view showing another example of the image forming apparatus according to the present exemplary embodiment.

An image forming apparatus 120 shown in FIG. 3 is a tandem type multicolor image forming apparatus on which four process cartridges 300 are mounted. The image forming apparatus 120 is formed such that four process cartridges 300 are arranged in parallel on the intermediate transfer member 50, and one electrophotographic photoreceptor is used for each color. Further, the image forming apparatus 120 has the same configuration as the image forming apparatus 100 except that the image forming apparatus 120 is of a tandem type.

### EXAMPLES

Hereinafter, the electrophotographic photoreceptor of the present disclosure will be described in more detail with reference to examples. The materials, the used amounts, the ratios, the treatment procedures, and the like described in the following examples may be appropriately changed without departing from the spirit of the present disclosure. Therefore, the scope of the electrophotographic photoreceptor of the present disclosure should not be limitatively interpreted by the specific examples described below.

### Preparation of Electron Transport Material

### Preparation of Electron Transport Material (1)

6.4 parts by mass of an exemplary compound (P-1: referred to as “P-1α” in the table) which is an electron transport material represented by General Formula (P) and having an α-type crystal form (CCDC No.: CCDC196996), 72 parts by mass of zirconia beads having a diameter of 0.3 mm, and 1.0 part by mass of sodium chloride are added to a container made of zirconia, and the mixture is pulverized at a rotation speed of 500 rpm for 2 hours using a planetary mill device (P-7 Classic Line: manufactured by Fritsch). After the pulverization, the particles are separated by filtration while the zirconia beads are washed with 500 ml of distilled water. The obtained aqueous dispersion liquid of the particles is centrifuged, and the supernatant water is removed by decantation to isolate the electron transport material. The isolated electron transport material is repeatedly washed with water until the electrical conductivity reaches 10 S/cm or less and dried with a freeze dryer for 48 hours, thereby obtaining an electron transport material (1) having an aspect ratio and an average primary particle diameter listed in Table 1.

### Preparation of Electron Transport Material (2)

An electron transport material (2) is obtained in the same manner as in the preparation of the electron transport material (1) except that the material used is changed to an exemplary compound (P-1: referred to as “P-1β” in the table) which has a β-type crystal form (CCDC No.: CCDC196997) in place of the exemplary compound (P-1) having an α-type crystal form.

### Preparation of Electron Transport Material (3)

An electron transport material (3) is obtained in the same manner as in the preparation of the electron transport material (1) except that the material used is changed to an exemplary compound (Q-12) which has a crystal form (CCDC No.: CCDC798609).

### Preparation of Electron Transport Material (4)

An electron transport material (4) is obtained in the same manner as in the preparation of the electron transport material (1) except that the electron transport material is repeatedly washed with water until the electrical conductivity reaches 10 S/cm or less and dried with a freeze dryer for 48 hours without performing the step of pulverization with a planetary mill and the subsequent step of filtering and isolating the particles after the pulverization.

### Preparation of Electron Transport Material (C1)

An electron transport material (C1) is obtained in the same manner as in the preparation of the electron transport material (1) except that the material used is changed to the following compound (D) in which the crystal structure is (COD No.: COD8100240).

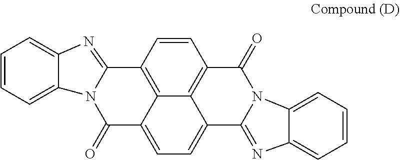 [SMILES: O=c1c2ccc3c4c(ccc(c24)c2nc4ccccc4n12)c(=O)n1c2ccccc2nc31]

### Preparation of Electron Transport Material (C2)

An electron transport material (C2) is obtained in the same manner as in the preparation of the electron transport material (1) except that the material used is changed to the following compound (E) in which the crystal structure is (CCDC No.: CCDC1872270).

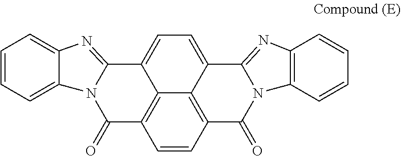 [SMILES: O=c1c2ccc3c(=O)n4c5ccccc5nc4c4ccc(c2c34)c2nc3ccccc3n12]

### Preparation of Electron Transport Material (C3)

An electron transport material (C3) is obtained in the same manner as in the preparation of the electron transport material (4) except that the material used is changed to the above-described compound (D) in which the crystal structure is COD8100240.

### Preparation of Undercoat Layer

### Preparation of Undercoat Layer (1)

A mixed solution is obtained by mixing 60 parts of the electron transport material (1), 13.5 parts of a curing agent (blocked isocyanate, SUMIDUR 3175, manufactured by Sumitomo Bayer Urethane Co., Ltd.), 15 parts of a butyral resin (S-LEC BM-1, manufactured by Sekisui Chemical Co., Ltd.), and 85 parts of methyl ethyl ketone. 38 parts of this mixed solution and 25 parts of methyl ethyl ketone are mixed and dispersed for 3 hours in a sand mill using glass beads having a diameter of 1 mmφ, thereby obtaining a dispersion liquid.

0.005 parts of dioctyltin dilaurate serving as a catalyst is added to the obtained dispersion liquid to obtain a coating solution for forming an undercoat layer. A cylindrical aluminum base material is coated with the coating solution by a dip coating method, and the coating solution is dried and cured at 170° C. for 30 minutes, thereby obtaining an undercoat layer having a film thickness of 10 μm.

### Preparation of Undercoat Layer (2)

An undercoat layer (2) is obtained in the same manner as in the preparation of the undercoat layer (1) except that the electron transport material in the undercoat layer (1) is changed to the electron transport material (2).

### Preparation of Undercoat Layer (3)

An undercoat layer (3) is obtained in the same manner as in the preparation of the undercoat layer (1) except that the electron transport material in the undercoat layer (1) is changed to the electron transport material (3).

### Preparation of Undercoat Layer (4)

An undercoat layer (4) is obtained in the same manner as in the preparation of the undercoat layer (1) except that the step of performing dispersion with a sand mill in the undercoat layer (1) is changed to a step of performing dispersion with a paint shaker for 2 hours.

### Preparation of Undercoat Layer (5)

An undercoat layer (5) is obtained in the same manner as described above except that the electron transport material (1) in the undercoat layer (4) is changed to the electron transport material (2).

### Preparation of Undercoat Layer (6)

An undercoat layer (6) is obtained in the same manner as described above except that the electron transport material (1) in the undercoat layer (4) is changed to the electron transport material (3).

### Preparation of Undercoat Layer (7)

An undercoat layer (7) is obtained in the same manner as described above except that the electron transport material (1) in the undercoat layer (4) is changed to the electron transport material (4).

### Preparation of Undercoat Layers (8) and (9)

Each of undercoat layers (8) and (9) is obtained in the same manner as described above except that the content of the electron transport material (1) in the undercoat layer (1) is changed to the content in the specification listed in the table with respect to the total solid content of the undercoat layer.

### Preparation of Undercoat Layers (10) and (11)

Each of undercoat layers (10) and (11) is obtained in the same manner as described above except that the thickness of the undercoat layer (1) is changed to the thickness listed in the table.

### Preparation of Undercoat Layer (12)

An undercoat layer (12) is obtained in the same manner as described above except that the proportion of the metal oxide in the undercoat layer (1) is changed to 10% by mass in the specification.

### Preparation of Undercoat Layer (1) for Comparative Example

An undercoat layer (1) for a comparative example is obtained in the same manner as described above except that the electron transport material (1) in the undercoat layer (1) is changed to the electron transport material (C1).

### Preparation of Undercoat Layer (2) for Comparative Example

An undercoat layer (2) for a comparative example is obtained in the same manner as described above except that the electron transport material (1) in the undercoat layer (1) is changed to the electron transport material (C2).

### Preparation of Undercoat Layer (3) for Comparative Example

An undercoat layer (3) for a comparative example is obtained in the same manner as described above except that the electron transport material (1) in the undercoat layer (1) is changed to the electron transport material (C3).

The crystal density of the electron transport material in the undercoat layer determined by the above-described measuring method, the FWHM, the LUMO energy level, the maximum value Nmax, and the aspect ratio and the average primary particle diameter of the electron transport material are shown in Table 1.

In Table 1, “crystal density” denotes the crystal density of the electron transport material in the undercoat layer.

In Table 1, “FWHM” denotes the full width at half maximum of the maximum intensity peak in the X-ray diffraction spectrum measured in the thickness direction of the undercoat layer.

In Table 1, “maximum value Nmax” denotes the value of the maximum value Nmax among alignment indices N represented by Equation (1) in a case where the relative integrated intensity of the maximum intensity peak in the X-ray diffraction spectrum obtained by measuring the undercoat layer in the thickness direction is defined as I₁ and the relative integrated intensity of the maximum intensity peak in the X-ray diffraction spectrum obtained by measuring the undercoat layer in a powder state with a volume average particle diameter of m or less is defined as I₂.

In Table 1, “LUMO” denotes the LUMO energy level of the undercoat layer.

In Table 1, “content” in the columns of “electron transport material” denotes the content of the electron transport material with respect to the total solid content of the undercoat layer.

In Table 1, “proportion of metal oxide” denotes the proportion of metal oxide in the total solid content of the undercoat layer.

### Examples 1 to 12 and Comparative Examples 1 to 3

### Formation of Charge Generation Layer

A mixture of 15 parts by mass of hydroxygallium phthalocyanine having diffraction peaks at positions where Bragg angles (2θ+0.2°) in an X-ray diffraction spectrum using Cuka characteristic X-rays are at least 7.3°, 16.0°, 24.9°, and 28.0° as the charge generation material, 10 parts by mass of vinyl chloride-vinyl acetate copolymer resin (VMCH, manufactured by Nippon Unicar Company Limited) as a binder resin, and 200 parts by mass of n-butyl acetate is stirred and dispersed in a sand mill for 4 hours using glass beads having a diameter of 1 mmφ. 175 parts by mass of n-butyl acetate and 180 parts by mass of methyl ethyl ketone are added to the obtained dispersion liquid, and the mixture is stirred, thereby obtaining a coating solution for forming a charge generation layer. The outer peripheral surface of the undercoat layer of the kind listed in the table is dipped in and coated with the coating solution for forming a charge generation layer, and the solution is dried at 150° C. for 15 minutes, thereby forming a charge generation layer having a film thickness of 0.2 μm.

### Formation of Charge Transport Layer

38 parts by mass of the charge transport agent (HT-1) shown below, 10 parts by mass of the charge transport agent (HT-2) shown below, 52 parts by mass of the polycarbonate resin (A) (viscosity average molecular weight: 46,000) shown below, and 0.3 part by mass of a fluorine-containing graft polymer (GF-500, manufactured by Toagosei Co., Ltd.) as a dispersion assistant are added to and dissolved in 800 parts by mass of tetrahydrofuran, 8 parts by mass of ethylene tetrafluoride resin (LUBRON L5, manufactured by Daikin Industries, Ltd., average particle diameter of 300 nm) is added thereto and dispersed at 5,500 rpm for 2 hours using a homogenizer (ULTRA-TURRAX, manufactured by TKA Japan K.K.), thereby obtaining a coating solution for forming a charge transport layer. The charge generation layer is coated with the coating solution, and the solution is dried at 140° C. for 40 minutes, thereby forming a charge transport layer having a film thickness of 30 μm. This charge transport layer is defined as an electrophotographic photoreceptor.

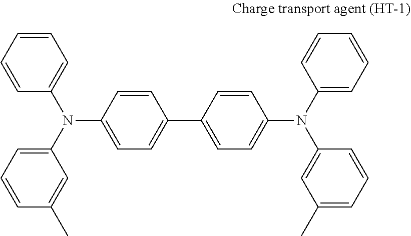

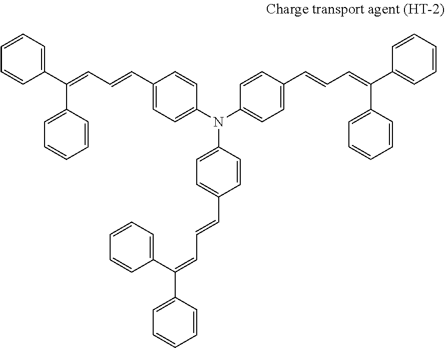

In the formulae, the numerical values denote the molar ratio (mol %).

### Evaluation

The electrophotographic photoreceptor of each example or each comparative example is mounted on a modified image forming apparatus DocuCentre C5570 (manufactured by FUJIFILM Business Innovation Corporation), and the following evaluations are performed. The evaluation results are listed in Table 1.

### Evaluation of Charge Maintainability

A photoreceptor is charged with a scorotron charger having a grid application voltage of −800 V in an environment of a temperature of 20° C. and a relative humidity of 40%, and 1,000,000 sheets of images are output in a state where the photoreceptor is not exposed to light. Thereafter, the photoreceptor is charged again with a scorotron charger having an application voltage of −800 V, and the potential is measured 200 msec after the charging. A value (potential drop amount) obtained by subtracting the potential of the photoreceptor after 150 msec from the potential measured during the initial charging at a voltage of −800 V is defined as an index of the charging properties.
A: The measured potential is greater than −15 V.
B: The measured potential is −15 V or less and greater than −18 V.
C: The measured potential is −18 V or less and greater than −20 V.
D: The measured potential is −20 V or less and greater than −22 Vr.
E: The measured potential is −22 V or less.

### Evaluation of Electron Transport Performance

A photoreceptor is charged with a scorotron charger having a grid application voltage of −700 V in an environment of a temperature of 20° C. and a relative humidity of 40% and irradiated with light at 4.0 erg/cm² using a semiconductor laser having a wavelength of 780 nm, and the potential is measured at a corresponding position 70 msec after the charging.
A: The potential after exposure to light is greater than −50 V.
B: The potential after exposure to light is −50 V or less and greater than −57 V.
C: The potential after exposure to light is −57 V or less and greater than −60 V.
D: The potential after exposure to light is −60 V or less and greater than −65 V.
E: The potential after exposure to light is −65 V or less.

TABLE 1

| | Undercoat layer | | | | | | | |
|---|---|---|---|---|---|---|---|---|
| | | LUMO | Electron transport material | | | | | |
| | Type of | energy | | | Crystal | | | |
| | undercoat | level | Type | Structure | density | FWHM | Nmax | Content |
| | layer | eV | — | — | g/cm³ | ° | — | mass % |
| Example 1 | Undercoat | 4.1 | 1 | P-1α | 1.72 | 0.36 | 4.9 | 70 |
| | layer (1) | | | | | | | |
| Example 2 | Undercoat | 4.1 | 2 | P-1β | 1.71 | 0.34 | 4.8 | 70 |
| | layer (2) | | | | | | | |
| Example 3 | Undercoat | 3.7 | 3 | Q-12 | 2.03 | 0.41 | 5.2 | 70 |
| | layer (3) | | | | | | | |
| Example 4 | Undercoat | 4.1 | 1 | P-1α | 1.72 | 0.26 | 5.8 | 70 |
| | layer (4) | | | | | | | |
| Example 5 | Undercoat | 4.1 | 2 | P-1β | 1.71 | 0.24 | 5.7 | 70 |
| | layer (5) | | | | | | | |
| Example 6 | Undercoat | 3.7 | 3 | Q-12 | 2.03 | 0.28 | 6.2 | 70 |
| | layer (6) | | | | | | | |
| Example 7 | Undercoat | 4.0 | 4 | P-1α | 1.72 | 0.26 | 6.6 | 70 |
| | layer (7) | | | | | | | |
| Example 8 | Undercoat | 4.1 | 1 | P-1α | 1.72 | 0.34 | 4.9 | 50 |
| | layer (8) | | | | | | | |
| Example 9 | Undercoat | 4.1 | 1 | P-1α | 1.72 | 0.34 | 4.9 | 80 |
| | layer (9) | | | | | | | |
| Example 10 | Undercoat | 4.1 | 1 | P-1α | 1.72 | 0.34 | 4.9 | 70 |
| | layer (10) | | | | | | | |
| Example 11 | Undercoat | 4.1 | 1 | P-1α | 1.72 | 0.34 | 4.9 | 70 |
| | layer (11) | | | | | | | |
| Example 12 | Undercoat | 4.1 | 1 | P-1α | 1.72 | 0.34 | 4.9 | 70 |
| | layer (12) | | | | | | | |
| Comparative | Undercoat | 3.7 | C1 | D | 1.59 | 0.32 | 2.3 | 70 |
| Example 1 | layer (1) for | | | | | | | |
| | comparative | | | | | | | |
| | example | | | | | | | |
| Comparative | Undercoat | 3.7 | C2 | E | 1.60 | 0.41 | 2.6 | 70 |
| Example 2 | layer (2) for | | | | | | | |
| | comparative | | | | | | | |
| | example | | | | | | | |
| Comparative | Undercoat | 3.7 | C3 | D | 1.59 | 0.32 | 3.1 | 70 |
| Example 3 | layer (3) for | | | | | | | |
| | comparative | | | | | | | |
| | example | | | | | | | |

| | Undercoat layer | | | | Evaluation | |
|---|---|---|---|---|---|---|
| | Electron transport material | | | | | Potential |
| | Average | | | | | drop |
| | primary | | | Proportion | | amount |
| | particle | Aspect | | of metal | Electron | of non- |
| | diameter | ratio | Thickness | oxide | transport | exposed |
| | nm | — | μm | mass % | performance | portion |
| Example 1 | 55.2 | 1.6 | 10 | 0 | A | A |
| Example 2 | 58.9 | 1.8 | 10 | 0 | A | A |
| Example 3 | 62.1 | 2.1 | 10 | 0 | B | A |
| Example 4 | 70.2 | 2.2 | 10 | 0 | B | A |
| Example 5 | 75.7 | 2.2 | 10 | 0 | B | A |
| Example 6 | 84.5 | 2.4 | 10 | 0 | C | A |
| Example 7 | 650 | 4.0 | 10 | 0 | C | B |
| Example 8 | 70 | 2.4 | 10 | 0 | C | A |
| Example 9 | 58.9 | 1.6 | 10 | 0 | B | C |
| Example 10 | 55.2 | 1.6 | 20 | 0 | C | C |
| Example 11 | 55.2 | 1.6 | 3 | 0 | A | C |
| Example 12 | 61 | 1.6 | 10 | 10 | B | D |
| Comparative | 195 | 4.8 | 10 | 0 | E | E |
| Example 1 | | | | | | |
| Comparative | 220 | 4.2 | 10 | 0 | E | E |
| Example 2 | | | | | | |
| Comparative | 710 | 7.2 | 10 | 0 | E | E |
| Example 3 | | | | | | |

Further, it is found that the electrophotographic photoreceptors of the examples have excellent electron transport properties as compared with the electrophotographic photoreceptors of the comparative examples as listed in Table 1. Further, it is found that the electrophotographic photoreceptors of the examples have excellent charge maintainability as compared with the electrophotographic photoreceptors of the comparative examples.

The present exemplary embodiment includes the following aspects.

(((1))) An electrophotographic photoreceptor comprising:
a conductive substrate;
an undercoat layer that is provided on the conductive substrate; and
a photosensitive layer provided on the undercoat layer,
wherein the undercoat layer contains a binder resin and an electron transport material having a crystal density of 1.62 g/cm³ or greater, and a full width at half maximum (FWHM) of a maximum intensity peak in an X-ray diffraction spectrum measured in a thickness direction is 5.0° or less.

(((2))) The electrophotographic photoreceptor according to (((1))),
wherein the electron transport material has an aspect ratio of 1.0 or greater and 2.5 or less.

(((3))) The electrophotographic photoreceptor according to (((2))),
wherein the electron transport material has an aspect ratio of 1.5 or greater and 2.3 or less.

(((4))) The electrophotographic photoreceptor according to (((1))),
wherein in a case where a relative integrated intensity of the maximum intensity peak in the X-ray diffraction spectrum obtained by measuring the undercoat layer in the thickness direction is defined as I₁, and a relative integrated intensity of the maximum intensity peak in the X-ray diffraction spectrum obtained by measuring the undercoat layer in a powder state with a volume average particle diameter of 5 μm or less is defined as I₂, a maximum value Nmax among alignment indices N represented by Equation (1) is 1.0 or greater and 5.5 or less.

$$Alignment index = \frac{\frac{{I}_{1}}{\sum {I}_{1}}}{\frac{{I}_{2}}{\sum {I}_{2}}} \qquad ( 1 )$$

(((5))) The electrophotographic photoreceptor according to (((1))),
wherein the undercoat layer has a LUMO energy level of 3.8 eV or greater and 4.2 eV or less.

(((6))) The electrophotographic photoreceptor according to (((1))),
wherein the electron transport material contains at least one of an electron transport material represented by General Formula (P) or an electron transport material represented by General Formula (Q),

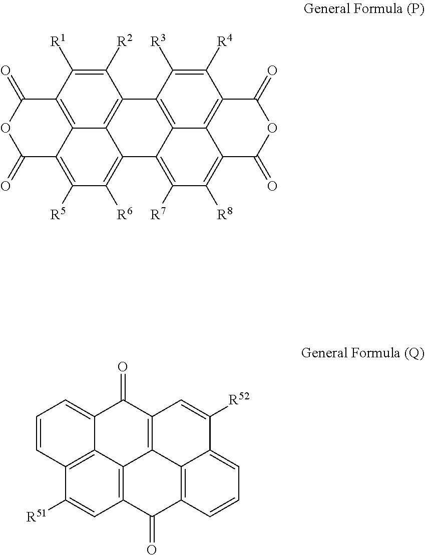

in General Formula (P), R¹, R², R³, R⁴, R⁵, R⁶, R⁷, and R⁸ each independently represent a hydrogen atom, an alkyl group, an alkoxy group, an aralkyl group, an aryl group, an alkoxycarbonyl group, or a halogen atom,
in General Formula (Q), R⁵¹ and R⁵² each independently represent a hydrogen atom, an alkyl group, an alkoxy group, an aralkyl group, an aryl group, an alkoxycarbonyl group, or a halogen atom.

(((7))) The electrophotographic photoreceptor according to (((6))),
wherein in General Formula (P), R¹, R², R³, R⁴, R⁵, R⁶, R⁷, and R⁸ each independently represent a hydrogen atom or a halogen atom.

(((8))) The electrophotographic photoreceptor according to (((6))), wherein in General Formula (Q), R⁵¹ and R⁵² represent a hydrogen atom.

(((9))) The electrophotographic photoreceptor according to (((1))), wherein the electron transport material has an average primary particle diameter of 500 nm or less.

(((10))) The electrophotographic photoreceptor according to (((1))),
wherein a content of the electron transport material is 60% by mass or greater and 75% by mass or less with respect to a total content of the binder resin component in the undercoat layer.

(((11))) The electrophotographic photoreceptor according to (((1))),
wherein the undercoat layer has a thickness of 5 μm or greater and 15 μm or less.

(((12))) The electrophotographic photoreceptor according to (((1))),
wherein a proportion of a metal oxide in the undercoat layer is 5% by mass or less with respect to a total solid content of the undercoat layer.

(((13))) A process cartridge comprising:
the electrophotographic photoreceptor according to any one of (((1))) to (((12))),
wherein the process cartridge is attachable to and detachable from an image forming apparatus.

(((14))) An image forming apparatus comprising:
the electrophotographic photoreceptor according to any one of (((1))) to (((12)));
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor comprising:
a conductive substrate;
an undercoat layer that is provided on the conductive substrate; and
a photosensitive layer provided on the undercoat layer,
wherein the undercoat layer contains a binder resin and an electron transport material having a crystal density of 1.62 g/cm³ or greater, and a full width at half maximum (FWHM) of a maximum intensity peak in an X-ray diffraction spectrum measured in a thickness direction is 5.0° or less.

2. The electrophotographic photoreceptor according to claim 1,
wherein the electron transport material has an aspect ratio of 1.0 or greater and 2.5 or less.

3. The electrophotographic photoreceptor according to claim 2,
wherein the electron transport material has an aspect ratio of 1.5 or greater and 2.3 or less.

4. The electrophotographic photoreceptor according to claim 1,
wherein in a case where a relative integrated intensity of the maximum intensity peak in the X-ray diffraction spectrum obtained by measuring the undercoat layer in the thickness direction is defined as I₁, and a relative integrated intensity of the maximum intensity peak in the X-ray diffraction spectrum obtained by measuring the undercoat layer in a powder state with a volume average particle diameter of 5 μm or less is defined as I₂,
a maximum value Nmax among alignment indices N represented by Equation (1) is 1.0 or greater and 5.5 or less.
$$Alignment index = \frac{\frac{{I}_{1}}{\sum {I}_{1}}}{\frac{{I}_{2}}{\sum {I}_{2}}} \qquad ( 1 )$$

5. The electrophotographic photoreceptor according to claim 1,
wherein the undercoat layer has a LUMO energy level of 3.8 eV or greater and 4.2 eV or less.

6. The electrophotographic photoreceptor according to claim 1,
wherein the electron transport material contains at least one of an electron transport material represented by General Formula (P) or an electron transport material represented by General Formula (Q), 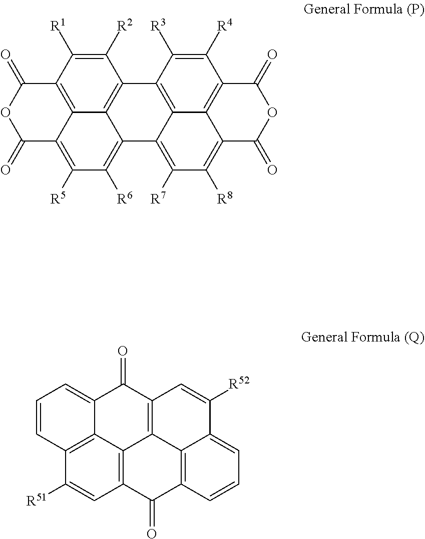
in General Formula (P), R¹, R², R³, R⁴, R⁵, R⁶, R⁷, and R⁸ each independently represent a hydrogen atom, an alkyl group, an alkoxy group, an aralkyl group, an aryl group, an alkoxycarbonyl group, or a halogen atom,
in General Formula (Q), R⁵¹ and R⁵² each independently represent a hydrogen atom, an alkyl group, an alkoxy group, an aralkyl group, an aryl group, an alkoxycarbonyl group, or a halogen atom.

7. The electrophotographic photoreceptor according to claim 6,
wherein in General Formula (P), R¹, R², R³, R⁴, R⁵, R⁶, R⁷, and R⁸ each independently represent a hydrogen atom or a halogen atom.

8. The electrophotographic photoreceptor according to claim 6,
wherein in General Formula (Q), R⁵¹ and R⁵² represent a hydrogen atom.

9. The electrophotographic photoreceptor according to claim 1,
wherein the electron transport material has an average primary particle diameter of 500 nm or less.

10. The electrophotographic photoreceptor according to claim 1,
wherein a content of the electron transport material is 60% by mass or greater and 75% by mass or less with respect to a total content of the binder resin component in the undercoat layer.

11. The electrophotographic photoreceptor according to claim 1,
wherein the undercoat layer has a thickness of 5 μm or greater and 15 μm or less.

12. The electrophotographic photoreceptor according to claim 1,
wherein a proportion of a metal oxide in the undercoat layer is 5% by mass or less with respect to a total solid content of the undercoat layer.

13. A process cartridge comprising:
the electrophotographic photoreceptor according to claim 1,
wherein the process cartridge is attachable to and detachable from an image forming apparatus.

14. A process cartridge comprising:
the electrophotographic photoreceptor according to claim 2,
wherein the process cartridge is attachable to and detachable from an image forming apparatus.

15. A process cartridge comprising:
the electrophotographic photoreceptor according to claim 3,
wherein the process cartridge is attachable to and detachable from an image forming apparatus.

16. A process cartridge comprising:
the electrophotographic photoreceptor according to claim 4,
wherein the process cartridge is attachable to and detachable from an image forming apparatus.

17. A process cartridge comprising:
the electrophotographic photoreceptor according to claim 5,
wherein the process cartridge is attachable to and detachable from an image forming apparatus.

18. A process cartridge comprising:
the electrophotographic photoreceptor according to claim 6,
wherein the process cartridge is attachable to and detachable from an image forming apparatus.

19. A process cartridge comprising:
the electrophotographic photoreceptor according to claim 7,
wherein the process cartridge is attachable to and detachable from an image forming apparatus.

20. An image forming apparatus comprising:
the electrophotographic photoreceptor according to claim 1;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.
